(19) United States
(12) Patent Application Publication
(10) Pub. No.: US 2024/0224371 A1
(43) Pub. Date: Jul. 4, 2024

(54) NETWORK TRAFFIC MANAGEMENT

(71) Applicant: Telefonaktiebolaget LM Ericsson (publ), Stockholm (SE)

(72) Inventors: Zhang ZHANG, Beijing (CN); Min WANG, Luleå (SE); Antonino ORSINO, Kirkkonummi (FI)

(21) Appl. No.: 18/289,064

(22) PCT Filed: Mar. 31, 2022
(86) PCT No.: PCT/EP2022/058680

§ 371 Date: Oct. 31, 2023

(30) Foreign Application Priority Data
May 7, 2021 (WO) PCT/CN2021/092036

(51) Int. Cl. H04W 76/27; H04W 74/0833; H04W 88/04; H04W 92/18

(52) U.S. Cl. CPC H04W 76/27; H04W 74/0833; H04W 88/04; H04W 92/18

(57) ABSTRACT

A method for managing network traffic in a network is provided. The method is performed by a remote user equipment (UE). The method includes receiving a first message from a first network node via a relay UE. The first message includes identity information for use in identifying the remote UE to the first network node when the first network node is serving the remote UE. The relay UE is capable of relaying network traffic between the first network node and the remote UE when the first network node is serving the remote UE.

### TECHNICAL FIELD

The disclosure relates to methods for managing network traffic and nodes configured to operate in accordance with those methods.

### BACKGROUND

The Third Generation Partnership Project (3GPP) Releases 12 and 13 specified a Long Term Evolution (LTE) Device-to-Device (D2D) technology, which is also known as Proximity Services (ProSe). Later, in 3GPP Releases 14 and 15, LTE Vehicle-to-Everything (V2X) related enhancements targeting the specific characteristics of vehicular communications are specified. The Third Generation Partnership Project (3GPP) started a new work item (WI) in August 2018 within the scope of 3GPP Release 16 to develop a new radio (NR) version of V2X communications. The NR V2X communications mainly target advanced V2X services. These services can be categorized into four use case groups: vehicles platooning, extended sensors, advanced driving and remote driving. The advanced V2X services may require an enhanced NR system and a new NR sidelink (NR SL) framework to meet stringent requirements in terms of latency and reliability. An NR V2X system may also have higher system capacity and better coverage and may allow for easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service, there are certain messages that are only of interest to the members of the platoon, making the members of the platoon a natural groupcast. In another example, a see-through use may involve only a pair of vehicles, for which unicast transmissions naturally fit. Therefore, NR sidelink can support broadcast (as in LTE), groupcast and unicast transmissions. Furthermore, NR sidelink may be designed in such a way that its operation is possible with and without network coverage and with varying degrees of interaction between the User Equipments (UEs) and the Network (NW), including support for standalone, network-less operation.

Each sidelink communication can be identified by a pair of source and destination Layer 2 identities (L2 IDs). The source L2 ID can be allocated by a UE itself. For unicast, the destination L2 ID is the source L2 ID of the peer UE and can be allocated by the peer UE. For groupcast/broadcast, the destination L2 ID can be mapped from a service or application.

In 3GPP Release 17, National Security Public Safety (NSPS) is considered to be one use case that can benefit from the already developed NR sidelink features in 3GPP Release 16. The 3GPP has decided to specify enhancements related to the NSPS use case taking the NR sidelink of 3GPP Release 16 as a baseline. In some scenarios, NSPS services need to operate with partial NW coverage or without NW coverage, such as the scenarios of indoor firefighting, forest firefighting, earthquake rescue, sea rescue, etc., or any scenario where the infrastructure is (at least partially) destroyed or not available. Therefore, coverage extension is an enabler for NSPS, for both NSPS services communicated between a UE and a cellular NW and NSPS services communicated between UEs over a sidelink. In 3GPP Release 17, a new Work Item Description (WID) on a NR sidelink relay has recently published, which aims to further explore NW coverage extension using a UE-to-NW relay, which can include both a Layer 2 (L2) UE-to-NW relay and a Layer 3 (L3) UE-to-NW relay.

An L2 UE-to-NW Relay UE provides the functionality to support connectivity to a fifth generation system (5GS) for Remote UEs. A protocol stack for an L2 UE-to-NW Relay UE is shown in FIGS. 1 and 2 for a user plane and a control plane respectively. That is, FIG. 1 illustrates a user plane stack for the L2 UE-to-NW Relay UE and FIG. 2 illustrates a control plane for the L2 UE-to-Network Relay UE.

The two endpoints of the Packet Data Convergence Protocol (PDCP) link are the Remote UE and the 5G base station gNodeB (gNB). This means that the Remote UE has its own context in the Radio Access Network (RAN) and the core NW. As such, the Remote UE has its own radio bearer, Radio Resource Control (RRC) connection, and Protocol Data Unit (PDU) session. The relay function is performed below the PDCP, e.g. at the adaptation layer. The network traffic of the Remote UE (both control plane and user plane network traffic) is transparently transferred between the Remote UE and the gNB over the L2 UE-to-NW Relay UE without any modifications.

The adaptation layer between the L2 UE-to-NW Relay UE and the gNB is able to differentiate between Uu bearers of a particular Remote UE. Uu bearers are bearers that allow the transmission of network traffic over an interface (namely, the Uu interface) connecting the L2 UE-to-NW Relay UE and the gNB. Different Remote UEs and different Uu bearers of the Remote UE can be indicated by additional information (e.g. UE identifiers (IDs) and bearer IDs) included in an adaptation layer header, which may be added to the PDCP PDU. The adaptation layer can be considered as part of a PDCP sublayer or a separate new layer between the PDCP sublayer and a Radio Link Control (RLC) sublayer.

When both the Remote UE and the L2 UE-to-NW Relay UE are in an RRC idle or inactive (RRC_IDLE/RRC_INACTIVE) state (or mode) and there is incoming downlink (DL) network traffic for the Remote UE, the NW may first page the Remote UE. The L2 UE-to-NW Relay UE can monitor the paging and inform the Remote UE that there is DL network traffic for the Remote UE. Then, both the Remote UE and the L2 UE-to-NW Relay UE can establish or resume an RRC connection to the gNB and the network traffic of the Remote UE can be transparently transferred between the Remote UE and gNB over the L2 UE-to-NW Relay UE.

An L3 UE-to-NW relay UE can relay unicast network traffic (uplink (UL) and DL network traffic) between the Remote UE and the NW. It provides a generic function that can relay any Internet Protocol (IP), Ethernet, or Unstructured network traffic. The protocol stack for an L3 UE-to-NW Relay UE is shown in FIG. 3. In FIG. 3, relaying is performed in a PDU layer. The Remote UE is invisible to the core NW. This means that the Remote UE does not have its own context and PDU session in the core NW. Instead, the network traffic of the Remote UE is forwarded in a PDU session of the Relay UE. For an IP PDU Session Type and IP network traffic over a PC5 interface (which is the interface between the Remote UE and the UE-to-NW Relay UE), the L3 UE-to-NW Relay UE may allocate an IP version 6 (IPv6) prefix or an IP version 4 (IPv4) address for the Remote UE.

In case the L3 UE-to-NW Relay UE is in an RRC idle or inactive state and there is incoming DL network traffic for the Remote UE, the NW may first page the L3 UE-to-NW Relay UE. This paging triggers the L3 UE-to-NW Relay UE to establish or resume an RRC connection. Then, the NW can send the network traffic of the Remote UE to the L3 UE-to-NW Relay UE. The L3 UE-to-NW Relay UE can further forward this network traffic to the Remote UE.

### SUMMARY

During random access, a Medium Access Control (MAC) Random Access Response (RAR) from the NW contains a temporary identity that is used by a MAC entity during random access. An example of a temporary identity is a temporary Cell-Radio Network Temporary Identifier (C-RNTI). A C-RNTI is a unique UE identification, which can be used as an identifier of an RRC connection and for scheduling. If random access to a cell is contention free or it is contention based but the contention is successfully resolved, a UE and the NW may use the temporary C-RNTI as the identifier of the UE when the UE enters an RRC connected (RRC_CONNECTED) state (or mode) in that cell.

A C-RNTI may be used for UE identification in the following RRC procedures:
During an RRC re-establishment procedure. In this case, the UE may set the C-RNTI in an RRCReestablishmentRequest message (i.e. a message comprising a request to establish RRC) to a C-RNTI that is used in a source Primary Cell (PCell) (e.g. a PCell that is the source of reconfiguration with sync or mobility from NR failure) or another PCell in which the trigger for the re-establishment occurred (and/or other cases).
During an RRC resume procedure. In this case, the UE may set the C-RNTI in an RRCResumeRequest (i.e. a message comprising a request to resume RRC) or an RRCResumeRequest1 message to a C-RNTI that the UE had in the PCell to which it was connected prior to suspension of the RRC connection.
When the UE reports a failure to the NW. In this case, the UE may set the C-RNTI in the UEInformationResponse message (i.e. a message comprises a response to a request for UE information) to a C-RNTI that is used in a source PCell (e.g. in case of handover failure) or another PCell (e.g. in the case of radio link failure).

In addition, during a random access (RA) procedure (e.g. a handover procedure) triggered by a UE in an RRC connected state, the UE may include its C-RNTI in Msg3 of the 4-step RA procedure or in MsgA of the 2-step RA procedure. In this way, the UE can identify itself to the gNB.

There currently exist certain challenge(s). For example, when a Remote UE that is in an RRC idle state connects to a NW indirectly via a UE-to-NW Relay UE, the Remote UE needs to setup its RRC connection towards the serving gNB of the Relay UE, via the Relay UE. In this case, the Remote UE does not perform random access by itself and thus does not have a C-RNTI allocated. This can cause problems in some procedures (e.g. any one or more of RRC reestablishment, RRC resume, RRC failure report, handover/path switch from a Relay UE to a gNB, etc.) in which a C-RNTI is used for UE identification. As the Remote UE cannot identify itself, the Remote UE also cannot be identified by the NW in those procedures.

Certain aspects of the disclosure and their embodiments may provide solutions to these or other challenges.

According to an aspect of the disclosure, there is provided a first method for managing network traffic in a network. The first method is performed by a remote user equipment (UE). The first method comprises receiving a first message from a first network node via a relay UE. The first message comprises identity information for use in identifying the remote UE to the first network node when the first network node is serving the remote UE. The relay UE is capable of relaying network traffic between the first network node and the remote UE when the first network node is serving the remote UE.

According to an aspect of the disclosure, there is provided a second method for managing network traffic in a network. The second method is performed by a relay UE. The second method comprises receiving, from a first network node of the network, a first message destined for a remote UE and comprising identity information for use in identifying the remote UE to the first network node when the first network node is serving the remote UE. The relay UE is capable of relaying network traffic between the first network node and the remote UE when the first network node is serving the remote UE. The second method comprises initiating transmission of the first message comprising the identity information towards the remote UE.

According to an aspect of the disclosure, there is provided a third method for managing network traffic in a network. The third method is performed by a first network node of the network. The third method comprises initiating transmission of a first message towards a remote UE via a relay UE in response to signaling from an entity. The signaling from the entity is indicative that the remote UE is to be served by the first network node via the relay UE. The relay UE is capable of relaying network traffic between the first network node and the remote UE when the first network node is serving the remote UE. The first message comprises identity information for use in identifying the remote UE to the first network node when the first network node is serving the remote UE.

According to an aspect of the disclosure, there is provided a fourth method for managing network traffic in a network. The fourth method is performed by an entity. The fourth method comprises signaling to a first network node. The signaling to the first network node is indicative that a remote UE is to be served by the first network node via a relay UE. The relay UE is capable of relaying network traffic between the first network node and the remote UE when the first network node is serving the remote UE.

According to an aspect of the disclosure, there is provided a method performed by a system. The method performed by the system comprises any two or more of the first method, the second method, the third method, and the fourth method.

According to an aspect of the disclosure, there is provided a remote UE comprising processing circuitry configured to operate in accordance with the first method. In some embodiments, the remote UE may comprise at least one memory for storing instructions which, when executed by the processing circuitry, cause the remote UE to operate in accordance with the first method.

According to an aspect of the disclosure, there is provided a relay UE comprising processing circuitry configured to operate in accordance with the second method. In some embodiments, the relay UE may comprise at least one memory for storing instructions which, when executed by the processing circuitry, cause the relay UE to operate in accordance with the second method.

According to an aspect of the disclosure, there is provided a first network node comprising processing circuitry configured to operate in accordance with the third method. In some embodiments, the first network node may comprise at least one memory for storing instructions which, when executed by the processing circuitry, cause the first network node to operate in accordance with the third method.

According to an aspect of the disclosure, there is provided an entity comprising processing circuitry configured to operate in accordance with the fourth method. In some embodiments, the entity may comprise at least one memory for storing instructions which, when executed by the processing circuitry, cause the entity to operate in accordance with the fourth method.

According to an aspect of the disclosure, there is provided a system comprising any two or more of the remote UE described earlier, the relay UE described earlier, the entity described earlier, and the first network node described earlier.

According to another aspect of the disclosure, there is provided a computer program comprising instructions which, when executed by processing circuitry, cause the processing circuitry to perform any one or more of the first method, the second method, the third method, and the fourth method.

According to another aspect of the disclosure, there is provided a computer program product, embodied on a non-transitory machine-readable medium, comprising instructions which are executable by processing circuitry to cause the processing circuitry to perform any one or more of the first method, the second method, the third method, and the fourth method.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example user plane stack for an L2 UE-to-NW Relay UE;

FIG. 2 is an example control plane for an L2 UE-to-NW Relay UE;

FIG. 3 is an example protocol stack for an L3 UE-to-NW Relay UE;

FIG. 4 is a block diagram illustrating a method performed by a Remote UE according to an embodiment;

FIG. 5 is a block diagram illustrating a method performed by a Relay UE according to an embodiment;

FIG. 6 is a block diagram illustrating a method performed by a first network node according to an embodiment;

FIG. 7 is a block diagram illustrating a method performed by an entity according to an embodiment;

FIG. 8 is a block diagram illustrating a method performed by a Remote UE according to an embodiment;

FIG. 9 is a block diagram illustrating a method performed by a Relay UE according to an embodiment;

FIG. 10 is a block diagram illustrating a method performed by a first network node according to an embodiment;

FIG. 11 is a block diagram illustrating a method performed by an entity according to an embodiment;

FIG. 12 is a schematic illustration of a system in accordance with some embodiments;

FIG. 13 is a schematic illustration of a UE in accordance with some embodiments;

FIG. 14 is a schematic illustration of a network node in accordance with some embodiments;

FIG. 15 is a schematic illustration of a host in accordance with some embodiments;

FIG. 16 is a schematic illustration of a virtualization environment in accordance with some embodiments; and

FIG. 17 is a schematic illustration of a host communicating via a network node with a UE in accordance with some embodiments.

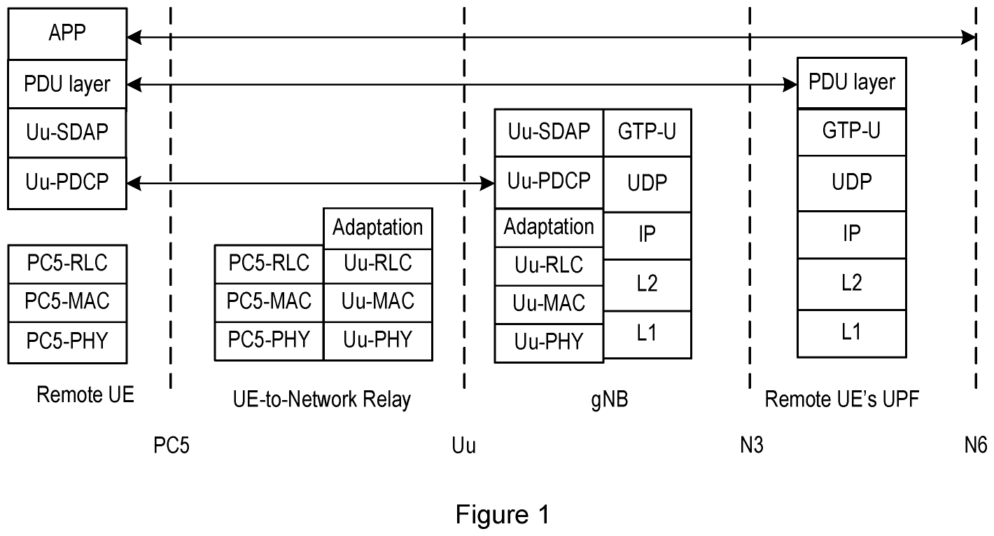

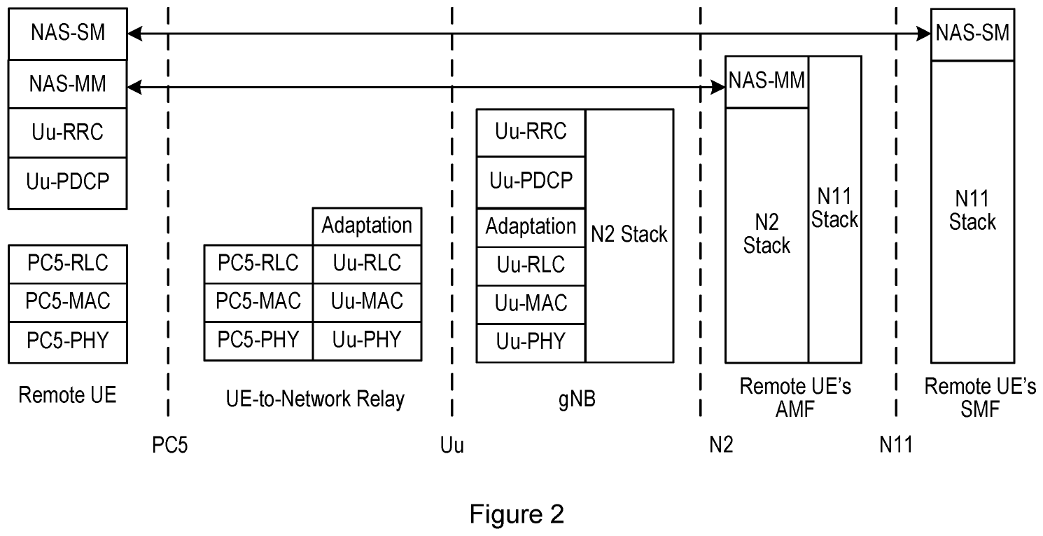

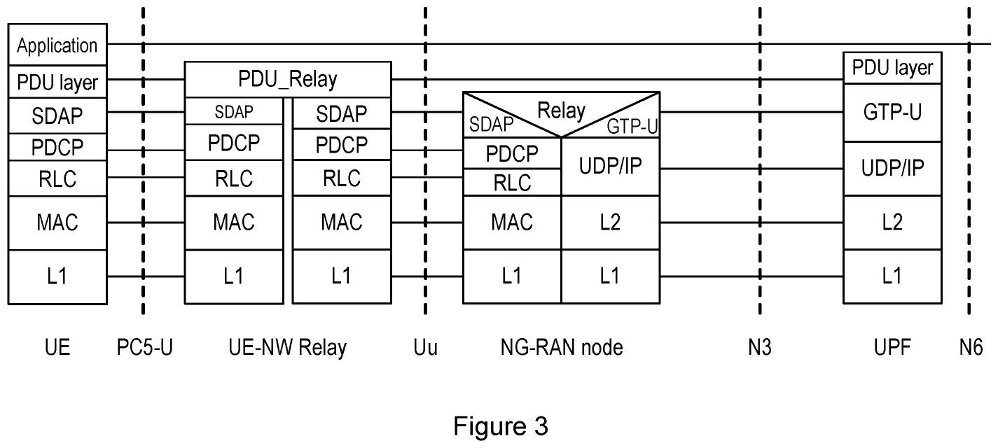

### DETAILED DESCRIPTION

Some of the embodiments contemplated herein will now be described more fully with reference to the accompanying drawings. Embodiments are provided by way of example to convey the scope of the subject matter to those skilled in the art.

The disclosure proposes mechanisms for remote UE identification with a UE-to-NW relay. More specifically, the disclosure proposes mechanisms for a remote UE to obtain identification information (e.g. a C-RNTI) when the remote UE wishes to connect or is connected to a NW indirectly via a (e.g. Layer 2) UE-to-NW relay UE.

The remote UE referred to herein is a UE that is remote from the NW. As such, the remote UE is unable to communicate directly with the NW (or any node of the network, i.e. any network node). Thus, a relay service is provided, which is a service that allows the remote UE to communicate with the NW (or a network node) via a relay UE. In this way, a UE-to-NW relay service can be provided.

The techniques described herein can include any one or more of the following:
Remote UE indicates the need of C-RNTI allocation to relay UE or gNB.
Relay UE indicates the need of C-RNTI allocation for a remote UE to gNB.
gNB allocates C-RNTI for the remote UE and informs the C-RNTI to the relay UE or the remote UE.
Relay UE informs that C-RNTI is allocated for the remote UE to the remote UE.

Alternatively, identification information (e.g. an identifier, ID) different from a C-RNTI (e.g. an L2 ID or any other identification information) may be used for the RM UE identification, such as in any (e.g. RRC) procedures where UE identification is needed.

Certain embodiments may provide one or more of the following technical advantage(s). With the mechanisms disclosed herein, the procedures (such as RRC procedures, e.g. RRC reestablishment, RRC resume, RRC failure report, etc.) where UE identification is needed can be performed properly. The proper performance of procedures may be essential in some situations, e.g. in a system with an L2 UE-to-NW relay.

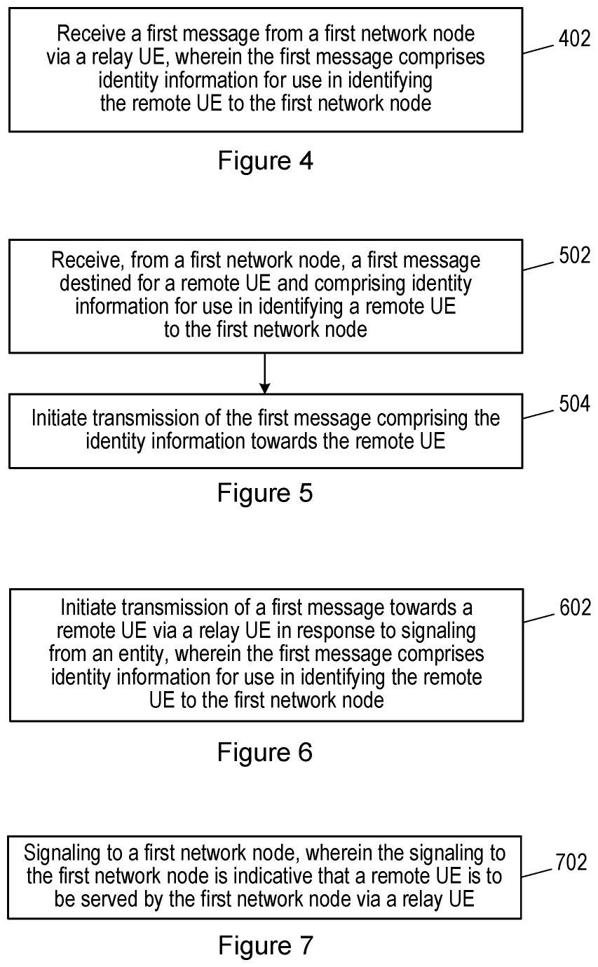

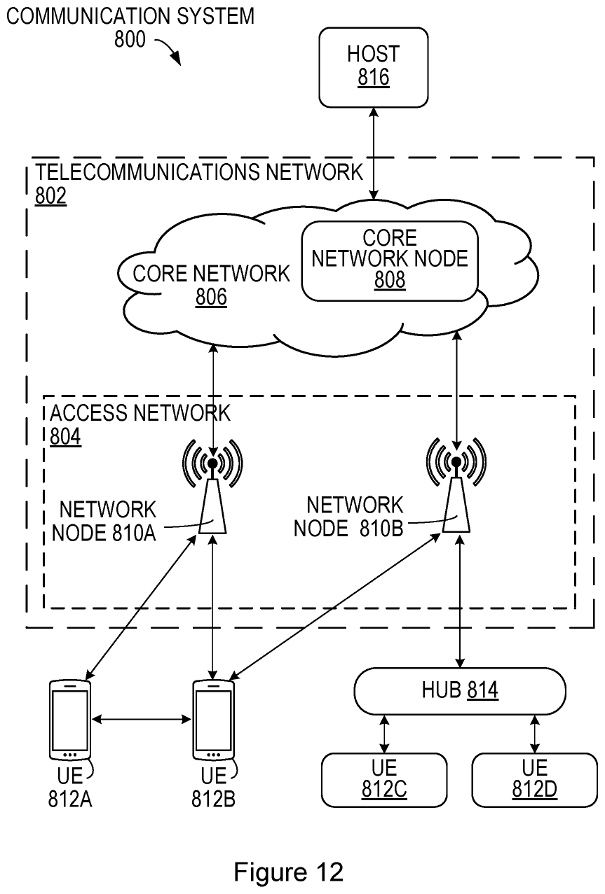

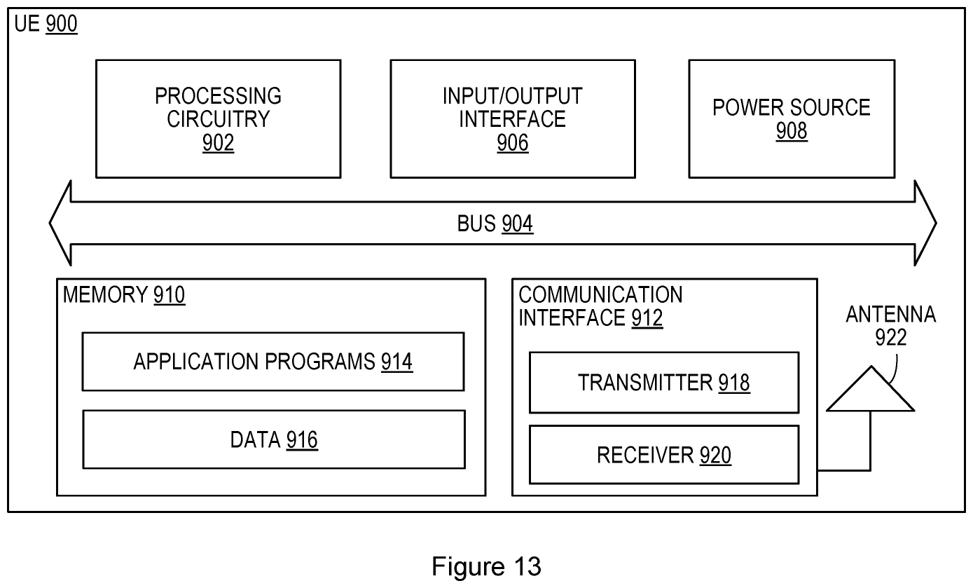

FIG. 4 illustrates a first method in accordance with some embodiments. The first method of FIG. 4 may be performed by a UE or wireless device (e.g. the UE 812 or UE 900 as described later with reference to FIGS. 12 and 13 respectively). The UE that performs the first method of FIG. 4 is referred to herein as the remote UE. The first method of FIG. 4 begins at step 402 with receiving a first message from a first network node via a relay UE. The first message comprises identity information for use in identifying the remote UE to the first network node when the first network node is serving the remote UE. The relay UE is capable of relaying network traffic between the first network node and the remote UE when the first network node is serving the remote UE.

In some embodiments, the first message may be received over a sidelink interface between the remote UE and the relay UE and a Uu interface between the relay UE and the first network node or over a Packet Control Unit (PCU) in a predefined protocol layer. Alternatively or in addition, in some embodiments, the first message may be received in a Uu Radio Resource Control (RRC) message.

In some embodiments, the identity information may be allocated to the remote UE by the first network node or by the relay UE.

In some embodiments, the first method may comprise signaling to the first network node via the relay UE. In these embodiments, the signaling to the first network node may be indicative that the remote UE is to be served by the first network node via the relay UE and the first message may be received in response to the signaling to the first network node.

In some embodiments, the signaling to the first network node may comprise a request and the first message may be a response to the request. In these embodiments, the request may be a request for a connection to be established for the remote UE to be served by the first network node via the relay UE and the response may comprise an instruction for the remote UE to use the established connection, or the request may be a request for a connection to be resumed for the remote UE to be served by the first network node via the relay UE and the response may comprise an instruction for the remote UE to use the resumed connection, or the request may be a request for a connection to be re-established for the remote UE to be served by the first network node via the relay UE and the response may comprise an instruction for the remote UE to use the re-established connection, or the request may be a request for a connection to be re-configured for the remote UE to be served by the first network node via the relay UE and the response may be comprise an instruction for the remote UE to use the re-configured connection.

In some embodiments, the request that the signaling to the first network node comprises may be an RRC request and the response to such a request may be an RRC response. Thus, herein, the request for a connection to be established (or set up) for the remote UE to be served by the first network node via the relay UE may be referred to as an “RRC Establishment Request” (or an “RRC Setup Request”) and the response to such a request may be referred to as an “RRC Establishment Response” (or an “RRC Setup Response”). Similarly, herein, the request for a connection to be resumed for the remote UE to be served by the first network node via the relay UE may be referred to as an “RRC Resume Request” and the response to such a request may be referred to as an “RRC Resume Response”. Similarly, herein, the request for a connection to be re-established for the remote UE to be served by the first network node via the relay UE may be referred to as an “RRC Reestablishment Request” and the response to such a request may be referred to as an “RRC Reestablishment Response”. Similarly, herein, the request for a connection to be re-configured for the remote UE to be served by the first network node via the relay UE may be referred to as an “RRC Reconfiguration Request” and the response to such a request may be referred to as an “RRC Reconfiguration Response”. In some embodiments, the RRC Establishment Request (or RRC Setup Request) and the RRC Establishment Response (or RRC Setup Response), or the RRC Resume Request and the RRC Resume Response, or the RRC Reestablishment Request and RRC Reestablishment Response may be used during an initial access of the remote UE. In some embodiments, the RRC Reconfiguration Request and RRC Reconfiguration Response may be used during a path switch of the remote UE.

In some embodiments, the signaling to the first network node may be indicative that the remote UE is to be served by the first network node via the relay UE by the signaling to the first network node may comprise any one or more of an indication of whether or not valid identity information is already allocated to the remote UE, a request for identity information to be allocated to the remote UE, an identifier that identifies the remote UE, an indication that the signaling to the first network node is from the remote UE via the relay UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to the remote UE, the request for identity information to be allocated to the remote UE, and the identifier that identifies the remote UE. In these embodiments, the signaling to the first network node may be over a sidelink interface between the remote UE and the relay UE and a Uu interface between the relay UE and the first network node or over a PCU in a predefined protocol layer, and/or the signaling to the first network node may only occur if the identity information already allocated to the remote UE is invalid and/or the first network node is a different network node to a second network node of the network that last served the remote UE.

In some embodiments, the signaling to the first network node may comprise one or both of the indication that the signaling to the first network node is from the remote UE via the relay UE and the indication that identity information needs to be allocated to the remote UE, and the signaling to the first network node may be RRC signaling. In some embodiments, the signaling to the first network node may comprise the request for the RRC connection to be set up for the remote UE if identity information already allocated to the remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node may be indicative that the remote UE is to be served by the first network node via the relay UE by the signaling to the first network node indicating that the remote UE has connected to the first network node via the relay UE and/or the first network node has started to serve the remote UE via the relay UE.

FIG. 5 illustrates a second method in accordance with some embodiments. The second method of FIG. 5 may be performed by a UE or wireless device (e.g. the UE 812 or UE 900 as described later with reference to FIGS. 12 and 13 respectively). The UE that performs the second method of FIG. 5 is referred to herein as the relay UE. The second method of FIG. 5 begins at step 502 with receiving, from a first network node of the network, a first message destined for a remote UE and comprising identity information for use in identifying the remote UE to the first network node when the first network node is serving the remote UE. The relay UE is capable of relaying network traffic between the first network node and the remote UE when the first network node is serving the remote UE. At step 504, transmission of the first message comprising the identity information is initiated towards the remote UE.

In some embodiments, the relay UE may be aware that the first message comprises the identity information. In other embodiments, the relay UE may be unaware that the first message comprises the identity information.

In some embodiments, the transmission of the first message may be initiated over a sidelink interface between the remote UE and the relay UE or over a Packet Control Unit, PCU, in a predefined protocol layer.

In some embodiments, the transmission of the first message may be initiated in response to signaling from the remote UE to the first network node via the relay UE, wherein the signaling from the remote UE may be indicative that the remote UE is to be served by the first network node via the relay UE.

In some embodiments, the signaling from the remote UE may comprise a request and the first message may be a response to the request. In these embodiments, the request may be a request for a connection to be established for the remote UE to be served by the first network node via the relay UE and the response may comprise an instruction for the remote UE to use the established connection, or the request may be a request for a connection to be resumed for the remote UE to be served by the first network node via the relay UE and the response may comprise an instruction for the remote UE to use the resumed connection, the request may be a request for a connection to be re-established for the remote UE to be served by the first network node via the relay UE and the response may comprise an instruction for the remote UE to use the re-established connection, or the request may be a request for a connection to be re-configured for the remote UE to be served by the first network node via the relay UE and the response may comprise an instruction for the remote UE to use the re-configured connection.

In some embodiments, the signaling from the remote UE may be indicative that the remote UE is to be served by the first network node via the relay UE by the signaling from the remote UE comprising any one or more of an indication of whether or not valid identity information is already allocated to the remote UE, a request for identity information to be allocated to the remote UE, an identifier that identifies the remote UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling from the remote UE may further comprise information on a pairing between the remote UE and the relay UE. In some embodiments, the information on the pairing may signal that an RRC connection is to be set up for the remote UE.

In some embodiments, the signaling from the remote UE may comprise any one or more of the indication of whether or not valid identity information is already allocated to the remote UE, the request for identity information to be allocated to the remote UE, and an identifier that identifies the remote UE. In these embodiments, the signaling from the remote UE may be over a sidelink interface between the remote UE and the relay UE and a Uu interface between the relay UE and the first network node or over a Packet Control Unit, PCU, in a predefined protocol layer, and/or the signaling from the remote UE may only occur if the identity information already allocated to the remote UE is invalid and/or the first network node is a different network node to a second network node of the network that last served the remote UE.

In some embodiments, the signaling from the remote UE may comprise the indication that identity information needs to be allocated to the remote UE, and the signaling from the remote UE may be RRC signaling. In some embodiments, the signaling from the remote UE may comprise the request for an RRC connection to be set up for the remote UE if identity information already allocated to the remote UE is invalid and/or the relay UE is in an RRC connected state. In some embodiments, the signaling from the remote UE may comprise the request for the remote UE to randomly access the first network node if one or both of the relay UE and the remote UE is in an RRC idle state.

In some embodiments, the signaling from the remote UE may be indicative that the remote UE is to be served by the first network node via the relay UE by the signaling from the remote UE indicating that the remote UE has connected to the first network node via the relay UE and/or the first network node has started to serve the remote UE via the relay UE.

In some embodiments, the second method may comprise signaling to the first network node, wherein the signaling to the first network node may be indicative that the remote UE is to be served by the first network node via the relay UE and the first message may be received in response to the signaling to the first network node.

In some embodiments, the signaling to the first network node may be indicative that the remote UE is to be served by the first network node via the relay UE by the signaling to the first network node comprising any one or more of an indication of whether or not valid identity information is already allocated to the remote UE, a request for identity information to be allocated to the remote UE, an identifier that identifies the remote UE, an indication that the signaling to the first network node is from the remote UE via the relay UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to the remote UE, the request for identity information to be allocated to the remote UE, and an identifier that identifies the remote UE. In these embodiments, the signaling to the first network node may be over a sidelink interface between the remote UE and the relay UE and a Uu interface between the relay UE and the first network node or over a Packet Control Unit, PCU, in a predefined protocol layer, and/or the signaling to the first network node may only occur if the identity information already allocated to the remote UE is invalid and/or the first network node is a different network node to a second network node of the network that last served the remote UE.

In some embodiments, the signaling to the first network node may comprise one or both of the indication that the signaling to the first network node is from the remote UE via the relay UE and the indication that identity information needs to be allocated to the remote UE, wherein the signaling to the first network node is RRC signaling. In some embodiments, the signaling to the first network node may comprise the request for an RRC connection to be set up for the remote UE if identity information already allocated to the remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node may be indicative that the remote UE is to be served by the first network node via the relay UE by the signaling to the first network node indicating that the remote UE has connected to the first network node via the relay UE and/or the first network node has started to serve the remote UE via the relay UE.

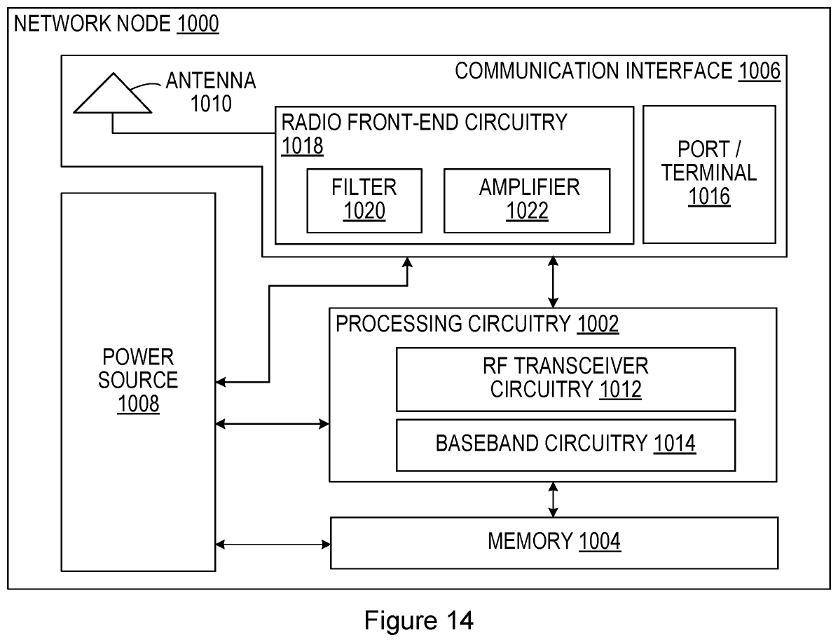

FIG. 6 illustrates a third method in accordance with some embodiments. The third method of FIG. 6 may be performed by a network node (e.g. the network node 810 or network node 1000 as described later with reference to FIGS. 12 and 14 respectively). The network node that performs the third method of FIG. 6 may be referred to herein as a first network node. The third method of FIG. 6 begins at step 602 with initiating transmission of a first message towards a remote UE via a relay UE in response to signaling from an entity. The signaling from the entity is indicative that the remote UE is to be served by the first network node via the relay UE. The relay UE is capable of relaying network traffic between the first network node and the remote UE when the first network node is serving the remote UE. The first message comprises identity information for use in identifying the remote UE to the first network node when the first network node is serving the remote UE.

In some embodiments, the entity may be the relay UE. In other embodiments, the entity may be the remote UE and the signaling can be via the relay UE. In yet other embodiments, the entity may be a second network node of the network. In these embodiments, the second network node may be a network node that last served the remote UE.

In some embodiments, the signaling may comprise a request and the first message may be a response to the request. In these embodiments, the request may be a request for a connection to be established for the remote UE to be served by the first network node via the relay UE and the response may comprise an instruction for the remote UE to use the established connection, or the request may be a request for a connection to be resumed for the remote UE to be served by the first network node via the relay UE and the response may comprise an instruction for the remote UE to use the resumed connection, the request may be a request for a connection to be re-established for the remote UE to be served by the first network node via the relay UE and the response may comprise an instruction for the remote UE to use the re-established connection, or the request may be a request for a connection to be re-configured for the remote UE to be served by the first network node via the relay UE and the response may comprise an instruction for the remote UE to use the re-configured connection.

In some embodiments, the entity may be the relay UE, or the entity may be the remote UE and the signaling may be via the relay UE. In these embodiments, the signaling may be indicative that the remote UE is to be served by the first network node via the relay UE by the signaling comprising any one or more of an indication of whether or not valid identity information is already allocated to the remote UE, a request for identity information to be allocated to the remote UE, an identifier that identifies the remote UE, an indication that the signaling is from the remote UE via the relay UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling may further comprise information on a pairing between the remote UE and the relay UE. In some embodiments, the information on the pairing may signal that an RRC connection is to be set up for the remote UE.

In some embodiments, the signaling may comprise any one or more of the indication of whether or not valid identity information is already allocated to the remote UE, the request for identity information to be allocated to the remote UE, and an identifier that identifies the remote UE. In these embodiments, the signaling may be over a sidelink interface between the remote UE and the relay UE and a Uu interface between the relay UE and the first network node or over a PCU in a predefined protocol layer, and/or the signaling may only occur if the identity information already allocated to the remote UE is invalid and/or the first network node is a different network node to a second network node of the network that last served the remote UE.

In some embodiments, the signaling may comprise one or both of the indication that the signaling is from the remote UE via the relay UE and the indication that identity information needs to be allocated to the remote UE, and the signaling is RRC signaling. In some embodiments, the signaling may comprise the request for an RRC connection to be set up for the remote UE if identity information already allocated to the remote UE is invalid and/or the relay UE is in an RRC connected state. In some embodiments, the signaling may comprise the request for the remote UE to randomly access the first network node if one or both of the relay UE and the remote UE is in an RRC idle state.

In some embodiments, the signaling may be indicative that the remote UE is to be served by the first network node via the relay UE by the signaling indicating that the remote UE has connected to the first network node via the relay UE and/or the first network node has started to serve the remote UE via the relay UE.

FIG. 7 illustrates a fourth method in accordance with some embodiments. The fourth method of FIG. 7 may be performed by an entity. The entity can be a UE or wireless device (e.g. the UE 812 or UE 900 as described later with reference to FIGS. 12 and 13 respectively) or a network node (e.g. the network node 810 or network node 1000 as described later with reference to FIGS. 12 and 14 respectively). The fourth method of FIG. 7 begins at step 702 with signaling to a first network node. The signaling to the first network node is indicative that a remote UE is to be served by the first network node via a relay UE. The relay UE is capable of relaying network traffic between the first network node and the remote UE when the first network node is serving the remote UE.

In some embodiments, the entity may be the relay UE. In other embodiments, the entity may be the remote UE and the signaling to the first network node can be via the relay UE. In yet other embodiments, the entity may be a second network node of the network. In these embodiments, the second network node can be a network node that last served the remote UE.

In any of the embodiments, the identity information referred to herein may comprise a Radio Network Temporary Identifier (RNTI) and/or a Layer 2 identifier (L2 ID) for the remote UE or a Layer 3 identifier (L3 ID) for the remote UE. In some embodiments, the RNTI may comprise a Cell RNTI (C-RNTI) and/or a Sidelink Relay RNTI (SR-RNTI).

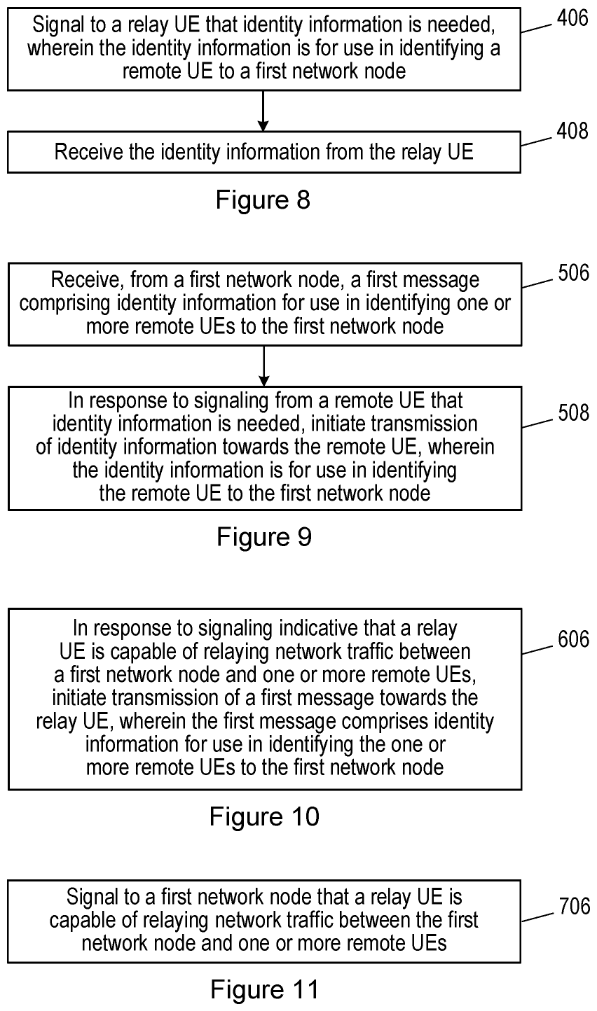

FIG. 8 illustrates a fifth method in accordance with some embodiments. The fifth method of FIG. 8 may be performed by a UE or wireless device (e.g. the UE 812 or UE 900 as described later with reference to FIGS. 12 and 13 respectively). The UE that performs the fifth method of FIG. 8 is referred to herein as the remote UE. The fifth method of FIG. 8 begins at step 406 with signaling to a relay UE that identity information is needed. The identity information is for use in identifying the remote UE to a first network node when the first network node is serving the remote UE. At step 408, the identity information is received from the relay UE. The relay UE is capable of relaying network traffic between the first network node and the remote UE when the first network node is serving the remote UE.

In some embodiments, the identity information may be received from the relay UE over a sidelink interface between the remote UE and the relay UE or over a Packet Control Unit (PCU) in a predefined protocol layer. Alternatively or in addition, in some embodiments, the identity information may be received in a Uu Radio Resource Control (RRC) message.

In some embodiments, the identity information may be allocated to the remote UE by the first network node or by the relay UE.

In some embodiments, the fifth method may comprise signaling to the first network node via the relay UE. The signaling to the first network node can be indicative that the relay UE is capable of relaying network traffic between the first network node and one or more remote UEs when the first network node is serving the one or more remote UEs.

In some embodiments, the signaling to the first network node may be indicative that the relay UE is capable of relaying network traffic by the signaling to the first network node comprising any one or more of an indication of whether or not valid identity information is already allocated to the remote UE, a request for identity information to be allocated to the remote UE, an identifier that identifies the remote UE, an indication that the signaling to the first network node is from the remote UE via the relay UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to the remote UE, the request for identity information to be allocated to the remote UE, and the identifier that identifies the remote UE. In these embodiments, the signaling to the first network node may be over a sidelink interface between the remote UE and the relay UE or over a PCU in a predefined protocol layer, and/or the signaling to the first network node may only occur if the identity information already allocated to the remote UE is invalid and/or the first network node is a different network node to a second network node of the network that last served the remote UE.

In some embodiments, the signaling to the first network node may comprise one or both of the indication that the signaling to the first network node is from the remote UE via the relay UE and the indication that identity information needs to be allocated to the remote UE, and the signaling to the first network node may be RRC signaling. In some embodiments, the signaling to the first network node may comprise the request for the RRC connection to be set up for the remote UE if identity information already allocated to the remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node may be indicative that the relay UE is capable of relaying network traffic by the signaling to the first network node indicating that the remote UE has connected to the first network node via the relay UE and/or the first network node has started to serve the remote UE via the relay UE.

FIG. 9 illustrates a sixth method in accordance with some embodiments. The sixth method of FIG. 9 may be performed by a UE or wireless device (e.g. the UE 812 or UE 900 as described later with reference to FIGS. 12 and 13 respectively). The UE that performs the sixth method of FIG. 9 is referred to herein as the relay UE. The sixth method of FIG. 9 begins at step 506 with receiving, from a first network node of the network, a first message comprising identity information for use in identifying one or more remote UEs to the first network node. The relay UE is capable of relaying network traffic between the first network node and the one or more remote UEs when the first network node is serving the one or more remote UEs. At step 508, in response to signaling from a remote UE that identity information is needed, transmission of identity information is initiated towards the remote UE. The identity information is for use in identifying the remote UE to the first network node when the first network node is serving the remote UE.

In some embodiments, the transmission of the identity information may be initiated over a sidelink interface between the remote UE and the relay UE or over a PCU in a predefined protocol layer.

In some embodiments, for a remote UE of the one or more UEs, the sixth method may comprise allocating identity information to the remote UE or the first message may comprise the identity information allocated to the remote UE by the first network node.

In some embodiments, the sixth method may comprise signaling to the first network node, wherein the signaling to the first network node may be indicative that the relay UE is capable of relaying network traffic between the first network node and one or more remote UEs when the first network node is serving the one or more remote UEs.

In some embodiments, the signaling to the first network node may be indicative that the relay UE is capable of relaying network traffic by the signaling to the first network node comprising any one or more of an indication of whether or not valid identity information is already allocated to a remote UE, a request for identity information to be allocated to a remote UE, an identifier that identifies a remote UE, an indication that the signaling to the first network node is from the remote UE via the relay UE, an indication that identity information needs to be allocated to a remote UE, a request for a Radio Resource Control connection to be set up for the remote UE, a request for the remote UE to randomly access the first network node, and information indicative that the relay UE is to relay network traffic between the first network node and one or more remote UEs.

In some embodiments, the identifier that identifies a remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to a remote UE, the request for identity information to be allocated to a remote UE, and an identifier that identifies a remote UE. In these embodiments, the signaling to the first network node may be over a sidelink interface between the remote UE and the relay UE or over a PCU in a predefined protocol layer, and/or the signaling to the first network node may only occur if the identity information already allocated to a remote UE is invalid and/or the first network node is a different network node to a second network node of the network that last served the remote UE.

In some embodiments, the signaling to the first network node may comprise one or both of the indication that the signaling to the first network node is from the remote UE via the relay UE and the indication that identity information needs to be allocated to a remote UE, and the signaling to the first network node may be RRC signaling. In some embodiments, the signaling to the first network node may comprise the request for an RRC connection to be set up for the remote UE if identity information already allocated to a remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node further may comprise a request for the relay UE to randomly access the first network node for the remote UE to set up an RRC connection and the sixth method may comprise receiving a second message from the first network node, wherein the second message may comprise identity information for use in identifying the relay UE to the first network node. In some embodiments, the second message may be the same message as the first message or the second message may be a different message from the first message.

In some embodiments, the signaling to the first network node may be indicative that the relay UE is capable of relaying network traffic by the signaling to the first network node indicating that a remote UE has connected to the first network node via the relay UE and/or the first network node has started to serve a remote UE via the relay UE.

In some embodiments, the signaling to the first network node may comprise an indication that identity information needs to be allocated to a remote UE linked to the relay UE.

In some embodiments, the relay UE may be in an RRC connected state, the signaling to the first network node may be RRC signaling, and/or the signaling to the first network node further may comprise an identifier that identifies a remote UE.

In some embodiments, the signaling to the first network node may further comprise an indication that the relay UE has transitioned to an RRC connected state.

In some embodiments, the first message may comprise identity information for use in identifying a plurality of remote UEs to the first network node.

In some embodiments, the sixth method may comprise initiating transmission of a third message towards the first network node, wherein the third message may comprise an indication of the identity information, from the first message, allocated by the relay UE to one or more remote UEs.

FIG. 10 illustrates a seventh method in accordance with some embodiments. The seventh method of FIG. 10 may be performed by a network node (e.g. the network node 810 or network node 1000 as described later with reference to FIGS. 12 and 14 respectively). The network node that performs the seventh method of FIG. 10 may be referred to herein as a first network node. The seventh method of FIG. 10 begins in response to signaling from an entity. The signaling is indicative that a relay UE is capable of relaying network traffic between the first network node and one or more remote UEs when the first network node is serving the one or more remote UEs. At step 606 transmission of a first message is initiated towards the relay UE. The first message comprises identity information for use in identifying the one or more remote UEs to the first network node.

In some embodiments, the entity may be the relay UE, or the entity may be the remote UE and the signaling may be via the relay UE, or the entity may be a second network node of the network, wherein the second network node can be a network node that last served the remote UE.

In some embodiments, for a remote UE of the one or more UEs, the seventh method may comprise allocating identity information to the remote UE.

In some embodiments, the first message may comprise the identity information allocated to the remote UE.

In some embodiments, the entity may be the relay UE or the entity may be the remote UE and the signaling may be via the relay UE. In these embodiments, the signaling may be indicative that the relay UE is capable of relaying network traffic by the signaling comprising any one or more of an indication of whether or not valid identity information is already allocated to a remote UE, a request for identity information to be allocated to a remote UE, an identifier that identifies a remote UE, an indication that the signaling is from the remote UE via the relay UE, an indication that identity information needs to be allocated to a remote UE, a request for a Radio Resource Control connection to be set up for the remote UE, a request for the remote UE to randomly access the first network node, and information indicative that the relay UE is to relay network traffic between the first network node and one or more remote UEs.

In some embodiments, the identifier that identifies a remote UE may signal that an RRC connection is to be set up for the remote UE and/or the signaling may further comprise information on a pairing between the remote UE and the relay UE. In some embodiments, the information on the pairing may signal that an RRC connection is to be set up for the remote UE.

In some embodiments, the signaling may comprise any one or more of the indication of whether or not valid identity information is already allocated to a remote UE, the request for identity information to be allocated to a remote UE, and an identifier that identifies a remote UE. In these embodiments, the signaling may be over a sidelink interface between the remote UE and the relay UE or over a PCU in a predefined protocol layer, and/or the signaling may only occur if the identity information already allocated to a remote UE is invalid and/or the first network node is a different network node to a second network node of the network that last served the remote UE.

In some embodiments, the signaling may comprise one or both of the indication that the signaling is from the remote UE via the relay UE and the indication that identity information needs to be allocated to a remote UE and the signaling may be RRC signaling.

In some embodiments, the signaling may comprise the request for an RRC connection to be set up for the remote UE if identity information already allocated to a remote UE is invalid and/or the relay UE is in an RRC connected state.

In some embodiments, the signaling may comprise the request for the remote UE to randomly access the first network node if one or both of the relay UE and the remote UE is in an RRC idle state.

In some embodiments, the signaling may further comprise a request for the relay UE to randomly access the first network node for the remote UE to set up an RRC connection and the seventh method may comprise initiating transmission of a second message towards the relay UE, wherein the second message may comprise identity information for use in identifying the relay UE to the first network node. In some embodiments, the second message may be the same message as the first message or the second message may be a different message from the first message.

In some embodiments, the signaling may be indicative that the relay UE is capable of relaying network traffic by the signaling indicating that a remote UE has connected to the first network node via the relay UE and/or the first network node has started to serve a remote UE via the relay UE.

In some embodiments, the entity may be the relay UE and the signaling may comprise an indication that identity information needs to be allocated to a remote UE linked to the relay UE.

In some embodiments, the relay UE may be in an RRC connected state, the signaling may be RRC signaling, and/or the signaling may further comprise an identifier that identifies a remote UE.

In some embodiments, the signaling may further comprise an indication that the relay UE has transitioned to an RRC connected state.

In some embodiments, the first message may comprise identity information for use in identifying a plurality of remote UEs to the first network node.

In some embodiments, the seventh method may comprise receiving a third message comprising an indication of the identity information, from the first message, allocated by the relay UE to one or more remote UEs.

FIG. 11 illustrates an eighth method in accordance with some embodiments. The eighth method of FIG. 11 may be performed by an entity. The entity can be a UE or wireless device (e.g. the UE 812 or UE 900 as described later with reference to FIGS. 12 and 13 respectively) or a network node (e.g. the network node 810 or network node 1000 as described later with reference to FIGS. 12 and 14 respectively). The eighth method of FIG. 11 begins at step 706 with signaling to a first network node that a relay UE is capable of relaying network traffic between the first network node and one or more remote UEs when the first network node is serving the one or more remote UEs.

In some embodiments, the entity may be a second network node of the network, wherein the second network node may be a network node that last served the one or more UEs.

In some embodiments, the entity may be a remote UE of the one or more remote UEs and the signaling to the first network node may be via the relay UE.

In some embodiments, the eighth method may comprise signaling to the relay UE that identity information is needed, wherein the identity information may be for use in identifying a remote UE of the one or more remote UEs to the first network node when the first network node is serving the remote UE, and receiving the identity information from the relay UE.

In some embodiments, the identity information may be received from the relay UE over a sidelink interface between the remote UE and the relay UE or over a PCU in a predefined protocol layer, and/or the identity information is received in a Uu RRC message.

In some embodiments, the identity information may be allocated to the remote UE by the first network node or by the relay UE.

In some embodiments, the signaling to the first network node may be indicative that the relay UE is capable of relaying network traffic by the signaling to the first network node comprising any one or more of an indication of whether or not valid identity information is already allocated to the remote UE, a request for identity information to be allocated to the remote UE, an identifier that identifies the remote UE, an indication that the signaling to the first network node is from the remote UE via the relay UE, an indication that identity information needs to be allocated to the remote UE, a request for a Radio Resource Control connection to be set up for the remote UE, a request for the remote UE to randomly access the first network node, and information indicative that the relay UE is to relay network traffic between the first network node and the remote UE.

In some embodiments, the identifier that identifies the remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to the remote UE, the request for identity information to be allocated to the remote UE, and the identifier that identifies the remote UE. In some of these embodiments, the signaling to the first network node may be over a sidelink interface between the remote UE and the relay UE or over a PCU in a predefined protocol layer, and/or the signaling to the first network node may only occur if the identity information already allocated to the remote UE is invalid and/or the first network node is a different network node to a second network node of the network that last served the remote UE.

In some embodiments, the signaling to the first network node may comprise one or both of the indication that the signaling to the first network node is from the remote UE via the relay UE and the indication that identity information needs to be allocated to the remote UE, wherein the signaling to the first network node is RRC signaling. In some embodiments, the signaling to the first network node may comprise the request for the RRC connection to be set up for the remote UE if identity information already allocated to the remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node may be indicative that the relay UE is capable of relaying network traffic by the signaling to the first network node indicating that the remote UE has connected to the first network node via the relay UE and/or the first network node has started to serve the remote UE via the relay UE.

In some embodiments, the entity may be the relay UE.

In some embodiments, the eighth method may comprise receiving, from the first network node of the network, a first message comprising identity information for use in identifying the one or more remote UEs to the first network node and initiating transmission of identity information towards the remote UE in response to signaling from a remote UE that identity information is needed, wherein the identity information may be for use in identifying the remote UE to the first network node when the first network node is serving the remote UE.

In some embodiments, the transmission of the identity information may be initiated over a sidelink interface between the remote UE and the relay UE or over a PCU in a predefined protocol layer.

In some embodiments, for a remote UE of the one or more UEs, the eighth method may comprise allocating identity information to the remote UE or the first message may comprise the identity information allocated to the remote UE by the first network node.

In some embodiments, the signaling to the first network node may be indicative that the relay UE is capable of relaying network traffic by the signaling to the first network node comprising any one or more of an indication of whether or not valid identity information is already allocated to a remote UE, a request for identity information to be allocated to a remote UE, an identifier that identifies a remote UE, an indication that the signaling to the first network node is from the remote UE via the relay UE, an indication that identity information needs to be allocated to a remote UE, a request for a Radio Resource Control connection to be set up for the remote UE, a request for the remote UE to randomly access the first network node, and information indicative that the relay UE is to relay network traffic between the first network node and one or more remote UEs.

In some embodiments, the identifier that identifies a remote UE may signal that an RRC connection is to be set up for the remote UE and/or the signaling to the first network node may further comprise information on a pairing between the remote UE and the relay UE. In some embodiments, the information on the pairing may signal that an RRC connection is to be set up for the remote UE.

In some embodiments, the signaling to the first network node may comprise any one or more of the indication of whether or not valid identity information is already allocated to a remote UE, the request for identity information to be allocated to a remote UE, and an identifier that identifies a remote UE. In some of these embodiments, the signaling to the first network node may be over a sidelink interface between the remote UE and the relay UE or over a PCU in a predefined protocol layer, and/or the signaling to the first network node may only occur if the identity information already allocated to a remote UE is invalid and/or the first network node is a different network node to a second network node of the network that last served the remote UE. In some embodiments, the signaling to the first network node may comprise one or both of the indication that the signaling is from the remote UE via the relay UE and the indication that identity information needs to be allocated to a remote UE, wherein the signaling to the first network node is RRC signaling. In some embodiments, the signaling to the first network node may comprise the request for an RRC connection to be set up for the remote UE if identity information already allocated to a remote UE is invalid and/or the relay UE is in an RRC connected state. In some embodiments, the signaling to the first network node may comprise the request for the remote UE to randomly access the first network node if one or both of the relay UE and the remote UE is in an RRC idle state.

In some embodiments, the signaling to the first network node may further comprise a request for the relay UE to randomly access the first network node for the remote UE to set up an RRC connection and the eighth method may comprise receiving a second message from the first network node, wherein the second message may comprise identity information for use in identifying the relay UE to the first network node.

In some embodiments, the signaling to the first network node may be indicative that the relay UE is capable of relaying network traffic by the signaling to the first network node indicating that a remote UE has connected to the first network node via the relay UE and/or the first network node has started to serve a remote UE via the relay UE.

In some embodiments, the signaling to the first network node may comprise an indication that identity information needs to be allocated to a remote UE linked to the relay UE.

In some embodiments, the relay UE may be in an RRC connected state, the signaling to the first network node may be RRC signaling, and/or the signaling to the first network node may further comprise an identifier that identifies a remote UE.

In some embodiments, the signaling to the first network node may further comprise an indication that the relay UE has transitioned to an RRC connected state.

In some embodiments, the first message may comprise identity information for use in identifying a plurality of remote UEs to the first network node.

In some embodiments, the eighth method may comprise initiating transmission of a third message towards the first network node, wherein the third message may comprise an indication of the identity information, from the first message, allocated by the relay UE to one or more remote UEs.

In some embodiments, the identity information referred to herein may comprise a Radio Network Temporary Identifier (RNTI) and/or a Layer 2 identifier (L2 ID) for the remote UE or a Layer 3 identifier (L3 ID) for the remote UE. In some embodiments, the RNTI may comprise a Cell RNTI (C-RNTI) and/or a Sidelink Relay RNTI (SR-RNTI).

The methods disclosed herein may refer to the NR Radio Access Technology (RAT) but the methods can also be applied to LTE RAT and any other RAT, such as any RAT enabling the direct transmission between two (or more) nearby devices, without any loss of meaning. Further, the remote UE will be referred to as the RMI UE, the relay UE will be referred to as the RL UE, and the network node will be referred to as the gNB. However, it will be understood that a network node other than a gNB can be used. The RM UE may need to transmit network traffic (e.g. one or more packets) to the gNB and/or receive network traffic (e.g. one or more packets) from the gNB via the RL UE. The RM UE is a UE that is remote from the NW. As such, the RM UE is unable to communicate directly with the NW (or any node of the NW, i.e. any network node). The RL UE is an intermediate UE. The RL UE allows the RM UE to communicate with a network node of the NW. Thus, the RL UE may also be referred to as a UE-to-NW relay UE.

Some of the methods disclosed herein may refer to an RRC state (or mode) of a UE. An RRC state of a UE refers to a state that the UE is in. Examples of an RRC state include an RRC idle state, an RRC connected state, and an RRC inactive state. An RRC idle state can be where a UE is not connected to the NW (e.g. any network nodes). An RRC connected state can be where a UE has both a connection to a RAN node (e.g. gNodeB) and a connection to a core NW node (e.g. an Access and Mobility Management Function (AMF)). An RRC inactive state can be where a UE is not connected to a RAN node (e.g. gNodeB), but the connection between the RAN node and the core NW node (e.g. AMF) is maintained.

The methods disclosed herein can be applied to various relay architectures. For example, this can include the L2 relay architecture. The network traffic referred to herein may also be referred to as signals. In the art, the link (e.g. radio link) over which signals are transmitted between at least two UEs for D2D operation is referred to as a side link (SL). Thus, the signals transmitted between UEs for D2D operation may be referred to as SL signals. The term SL may also interchangeably be referred to as a D2D link, a V2X link, a prose link, a peer-to-peer link, a PC5 link, etc. The SL signals may thus also interchangeably be referred to as D2D signals, V2X signals, prose signals, peer-to-peer signals, PC5 signals, etc.

In some embodiments, during or after establishing a PC5 connection with a RL UE, a RM UE may indicate to the RL UE whether it has identification information (e.g. a C-RNTI) allocated that is still valid, or the RM UE may explicitly send an identification information (C-RNTI) allocation request to the RL UE. The request may be sent using the PC5 interface (e.g. via PC5-S, PC5-RRC, SL MAC CE) or a control PCU in a certain protocol layer (e.g. the adaptation layer).

In some embodiments, the RM UE may include such an indication or request, or simply an identifier for the UE (RM UE ID), in a first RRC message for connection establishment (e.g. in the RRCSetupRequest), which it sends to the gNB via the RL UE.

In some embodiments, the RM UE may only send such information (i.e. indication or RM UE ID) or request when it does not have valid identification information (e.g. a valid C-RNTI, such as when the RM UE is currently in an RRC IDLE state or is out of coverage) or when the serving (or camping) cell of the RL UE is different from the last cell in which the RM UE obtained the identification information (e.g. C-RNTI). The cell information can be obtained from, for example, a discovery message sent by the RL UE.

In some embodiments, when the information (i.e. indication or RM UE ID) or request is sent to the RL UE, the RM UE may receive the identification information (e.g. C-RNTI) allocated to it (e.g. by the serving gNB of the RL UE) from the RL UE, such as over the PC5 interface (e.g. via PC5-S, PC5-RRC, SL MAC CE) or a control PCU in a certain protocol layer (e.g. the adaptation layer). When the information (i.e. indication or RM UE ID) or request is sent to the gNB, the RM UE may receive the identification information (e.g. C-RNTI) allocated to it (e.g. by the gNB that will serve the RM UE) from the gNB, such as using a Uu RRC message.

In some embodiments, the RM UE may not send any request for allocation of identification information (e.g. C-RNTI) to the gNB via the relay UE. However, it may be the case that the RM UE does not have valid identification information (e.g. a valid C-RNTI). The serving gNB of the relay UE may apply at least one of the following options to allocate identification information (e.g. a C-RNTI) to the remote UE.

Option 1: Identification information (e.g. a C-RNTI) may be allocated to the RM UE via the RL UE during a connection establishment procedure. In this case, the RL UE may already be in an RRC connected state. The RL UE may not initiate a random access channel (RACH) procedure to its gNB. The RM UE can send an RRC setup request message to the gNB via the RL UE. Upon reception of the RRC setup request message from the RL UE for the RM UE, the gNB becomes aware that the message is intended to setup an RRC connection for the RM UE (e.g. based on the RM UE ID carried in the message, optionally together with other information such as information on a pair relation between the RM UE and the RL UE). The gNB can simply allocate identification information (e.g. a C-RNTI) to the RM UE via the RL UE (e.g. it may be included in the RRC setup message).

Option 2: The RL UE may initiate a RACH procedure to the gNB for the RM UE when the RL UE is in an RRC idle state and the RM UE is in an RRC idle state. In this case, the RL UE may obtain identification information (e.g. a C-RNTI) for the RM UE from the gNB via the RACH procedure. The RL UE may also need to initiate a RACH procedure for itself to setup an RRC connection. Thus, the RL UE can obtain identification information (e.g. a C-RNTI) from the gNB for itself.

Option 3: The gNB may allocate identification information (e.g. a C-RNTI) to the RM UE via the RL UE over the PC5 interface (e.g. via PC5-S, PC5-RRC, SL MAC CE) or a control PCU in a certain protocol layer (e.g. the adaptation layer). This allocation may occur whenever the gNB knows that the RM UE has connected to the gNB or has started to be served by the gNB. For example, the allocation may occur upon reception of RRC signaling (e.g. RRC reconfiguration signaling) from another gNB (referred to herein as a second network node) which has previously served the RM UE, or upon reception of information or signaling that the RL UE will serve the relay for the RM UE.

In some embodiments, if the RL UE is in an RRC connected state, the RL UE may indicate in a (e.g. dedicated) RRC message (e.g. UEAssistanceInformation) that identification information (e.g. a C-RNTI) needs to be allocated to a linked RM UE. The RM UE may be identified by, for example, its L2 ID (or any other RM UE ID) in the RRC message. The RL UE can receive the identification information (e.g. C-RNTI) allocated for the RM UE from the gNB, such as via a (e.g. dedicated) RRC message. The RL UE may send the received identification information (e.g. C-RNTI) to the RM UE, such as over the PC5 interface. In some embodiments, in an RRC procedures (e.g. RRC reestablishment, RRC resume, RRC failure report, etc.) where identification information (e.g. a C-RNTI) is used for UE identification, the RM UE may fill in a UE ID field in the relevant RRC message(s) (e.g. RRCReestablishmentRequest, RRCResumeRequest, UEInformationResponse, etc.) with another ID, e.g. the L2 ID for the UE, for its identification.

In some embodiments, new identification information (e.g. a new RNTI) may be defined for sidelink relay transmission purposes (e.g. SR-RNTI). A range of identification information (e.g. a range of SR-RNTI) may be sent by the gNB to the RL UE when the RL UE is in an RRC connected state (or transmits/transitions to an RRC connected state) and, based on the UE capabilities, the UE may be a relay capable UE. The range of an SR-RNTI may be different from that of a C-RNTI. According to this, when the RM UE sends an indication to the RL UE that new identification information (e.g. a new RNTI) is needed, the RL UE may assign (e.g. straight away) new identification information (e.g. a new SR-RNTI) to the RM UE without informing the gNB about the request or communicating the request to the gNB. In some cases, once the RM UE receives a new SR-RNTI, the RM UE may consider the SR-RNTI as the new C-RNTI or may simply use the SR-RNTI to perform a RACH procedure or other RRC procedure where a UE ID is needed. Once the RL UE assigns identification information (e.g. a SR-RNTI) to the RM UE, the RL UE may send an indication to the gNB to inform the gNB which identification information (e.g. SR-RNTI) has been used.

In some embodiments, when receiving a (e.g. dedicated) RRC message from a RL UE, which indicates that identification information (e.g. a C-RNTI) needs to be allocated to a certain RM UE (which may optionally be identified by a UE ID, e.g. a L2 ID of the RM UE), the gNB may allocate the identification information (e.g. C-RNTI) for the RM UE. The gNB may inform the RL UE of this identification information (e.g. a C-RNTI), optionally together with a UE ID of the RM UE (e.g. the L2 ID of the RM UE), such as in a (e.g. dedicated) RRC message.

In some embodiments, when receiving a (e.g. dedicated) RRC message from a RM UE, which indicates that the message is sent from a RM UE and/or that identification information (e.g. a C-RNTI) needs to be allocated to the RM UE, the gNB may allocates the identification information (e.g. C-RNTI) for the RM UE. The gNB may inform the RM UE of this identification information (e.g. C-RNTI), such as in a (e.g. dedicated) RRC message.

In some embodiments, when a UE transits to an RRC connected state and that UE is (sidelink) relay capable (e.g. according to its UE capabilities), the gNB may assign a range of new identification information (e.g. a range of new RNTI, such as SR-RNTI) that this UE can use in case it becomes a RL UE. Once the gNB is informed by this or other RL UEs that the identification information (e.g. one or more SR-RNTI) has been used, the gNB may remove that identification information from the range that is available (e.g. remove RNTIs from the range of available SR-RNTI).

Although various examples have been provided for the identification information, it will be understood that any other identification may be used. For example, the RM UE may be identified by an identifier (ID) that is different from a C-RNTI, e.g. an L2 ID of the RM UE. The (e.g. Access Stratum (AS) layer) context of the RM UE stored at the gNB may be associated to that ID (e.g. L2 ID).

There is also provided a system. The system can comprise any two or more of the remote UE described herein, the relay UE described herein, the entity described herein, and the first network node described herein. A method performed by the system can comprise any two or more of the method described herein in respect of the remote UE, the method described herein in respect of the relay UE, the method described herein in respect of the entity, and the method described herein in respect of the first network node.

FIG. 12 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example illustrated in FIG. 12, the hub 814 communicates with the access network 804 to facilitate indirect communication between one or more UEs (e.g., UE 812c and/or 812d) and network nodes (e.g., network node 810b). In some examples, the hub 814 may be a controller, router, a content source and analytics node, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

FIG. 13 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile terminal, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs). The processing circuitry 902 may be operable to provide, either alone or in conjunction with other UE 900 components, such as the memory 910, UE 900 functionality. For example, the processing circuitry 902 may be configured to cause the UE 902 to perform the methods as described with reference to FIGS. 4, 5, 8 and/or 9.

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In some embodiments, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 900 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs). The network node 1000 includes processing circuitry 1002, a memory 1004, a communication interface 1006, and a power source 1008, and/or any other component, or any combination thereof. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, network node 1000 functionality. For example, the processing circuitry 1002 may be configured to cause the network node to perform the methods as described with reference to FIGS. 6, 7, 10 and/or 11.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown). The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 14 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

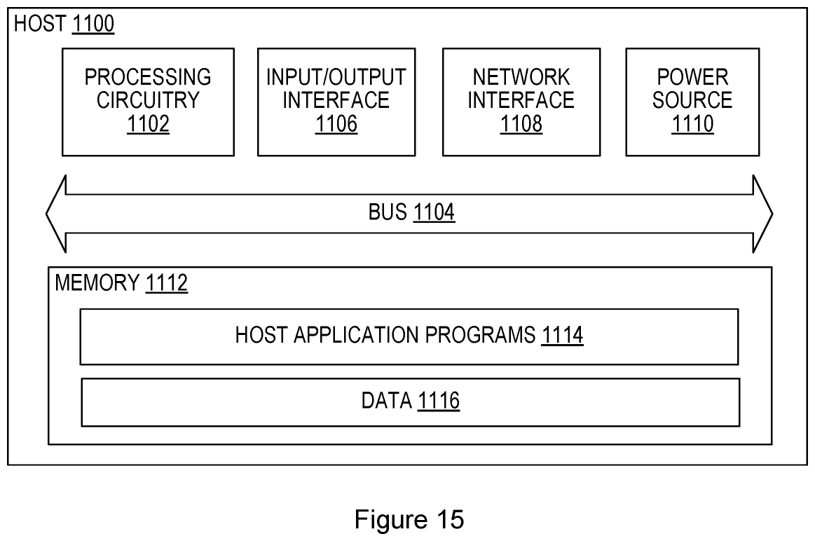

FIG. 15 is a block diagram of a host 1100, which may be an embodiment of the host 816 of FIG. 12, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 13 and 14, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

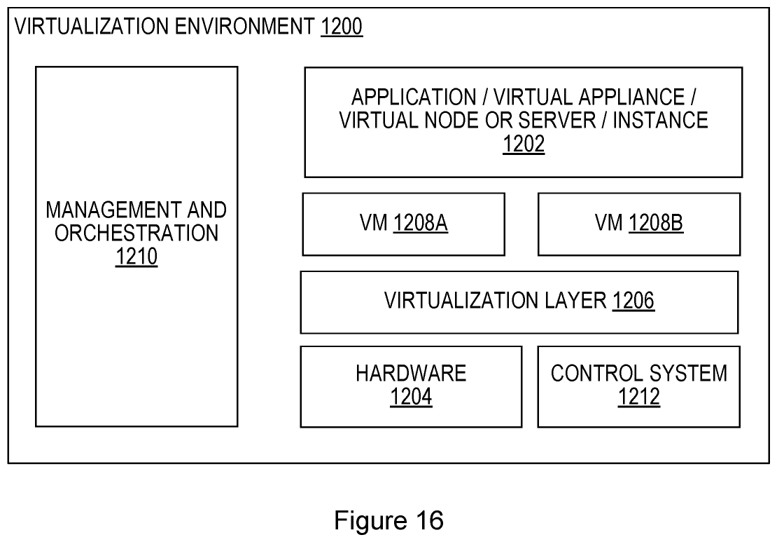

FIG. 16 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

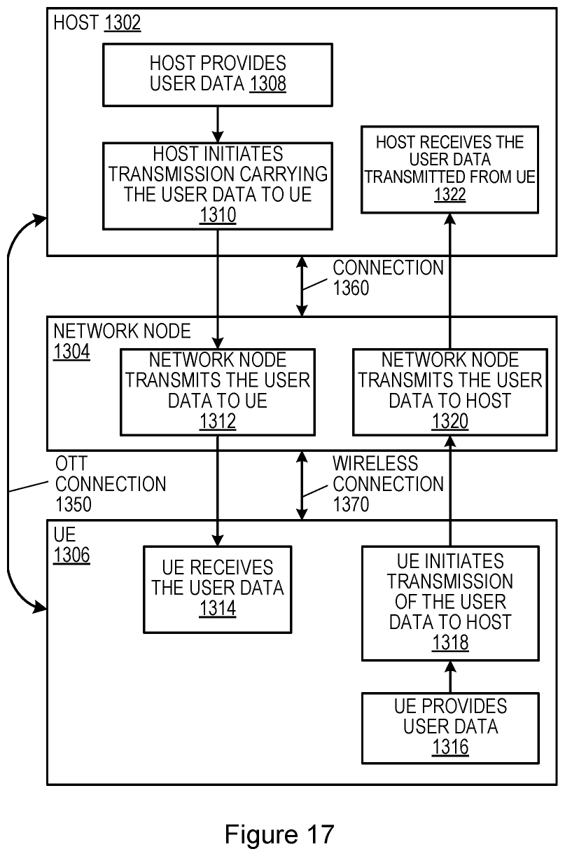

FIG. 17 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 12 and/or UE 900 of FIG. 13), network node (such as network node 810a of FIG. 12 and/or network node 1000 of FIG. 14), and host (such as host 816 of FIG. 12 and/or host 1100 of FIG. 15) discussed in the preceding paragraphs will now be described with reference to FIG. 17.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 12) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the latency and thereby provide benefits such as reduced user waiting time and better responsiveness.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

There is also provided a computer program comprising instructions which, when executed by processing circuitry (such as the processing circuitry of the remote UE, relay UE, entity, and/or first network node), cause the processing circuitry to perform at least part of the method described herein. There is provided a computer program product, embodied on a non-transitory machine-readable medium, comprising instructions which are executable by processing circuitry (such as the processing circuitry of the remote UE, relay UE, entity, and/or first network node) to cause the processing circuitry to perform at least part of the method described herein. There is provided a computer program product comprising a carrier containing instructions for causing processing circuitry (such as the processing circuitry of the remote UE, relay UE, entity, and/or first network node) to perform at least part of the method described herein. In some embodiments, the carrier can be any one of an electronic signal, an optical signal, an electromagnetic signal, an electrical signal, a radio signal, a microwave signal, or a computer-readable storage medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments are discussed below:

### Group A Embodiments

1. A method for managing network traffic in a network, wherein the method is performed by a remote user equipment, UE, the method comprising:
   signaling (406) to a relay UE that identity information is needed, wherein the identity information is for use in identifying the remote UE to a first network node when the first network node is serving the remote UE; and
   receiving (408) the identity information from the relay UE, wherein the relay UE is capable of relaying network traffic between the first network node and the remote UE when the first network node is serving the remote UE.
2. The method of embodiment 1, wherein:
   the identity information is received from the relay UE over a sidelink interface between the remote UE and the relay UE or over a Packet Control Unit, PCU, in a predefined protocol layer; and/or
   the identity information is received in a Uu Radio Resource Control, RRC, message.
3. The method of embodiment 1 or 2, wherein:
   the identity information is allocated to the remote UE by the first network node or by the relay UE.
4. The method of any of embodiments 1 to 3, the method comprising:
   signaling to the first network node via the relay UE, wherein the signaling is indicative that the relay UE is capable of relaying network traffic between the first network node and one or more remote UEs when the first network node is serving the one or more remote UEs.
5. The method of embodiment 4, wherein:
   the signaling is indicative that the relay UE is capable of relaying network traffic by the signaling comprising any one or more of:
      an indication of whether or not valid identity information is already allocated to the remote UE;
      a request for identity information to be allocated to the remote UE;
      an identifier that identifies the remote UE;
      an indication that the signaling is from the remote UE via the relay UE;
      an indication that identity information needs to be allocated to the remote UE;
      a request for a Radio Resource Control connection to be set up for the remote UE;
      a request for the remote UE to randomly access the first network node; and
      information indicative that the relay UE is to relay network traffic between the first network node and the remote UE.
6. The method of embodiment 5, wherein:
   the identifier that identifies the remote UE signals that an RRC connection is to be set up for the remote UE; and/or
   the signaling further comprises information on a pairing between the remote UE and the relay UE, wherein the information on the pairing signals that an RRC connection is to be set up for the remote UE.
7. The method of embodiment 5 or 6, wherein:
   the signaling comprises any one or more of the indication of whether or not valid identity information is already allocated to the remote UE, the request for identity information to be allocated to the remote UE, and the identifier that identifies the remote UE; and
   the signaling is over a sidelink interface between the remote UE and the relay UE or over a Packet Control Unit, PCU, in a predefined protocol layer; and/or
   the signaling only occurs if the identity information already allocated to the remote UE is invalid and/or the first network node is a different network node to a second network node of the network that last served the remote UE.
8. The method of any of embodiments 5 to 7, wherein:
   the signaling comprises one or both of the indication that the signaling is from the remote UE via the relay UE and the indication that identity information needs to be allocated to the remote UE; and
   the signaling is RRC signaling.
9. The method of any of embodiments 5 to 8, wherein:
   the signaling comprises the request for the RRC connection to be set up for the remote UE if identity information already allocated to the remote UE is invalid and/or the relay UE is in an RRC connected state.
10. The method of any of embodiments 5 to 9, wherein:
   the signaling comprises the request for the remote UE to randomly access the first network node if one or both of the relay UE and the remote UE is in an RRC idle state.
11. The method of any of embodiments 5 to 10, wherein:
   the signaling is indicative that the relay UE is capable of relaying network traffic by the signaling indicating that the remote UE has connected to the first network node via the relay UE and/or the first network node has started to serve the remote UE via the relay UE.
12. A method for managing network traffic in a network, wherein the method is performed by a relay user equipment, UE, the method comprising:
   receiving (506), from a first network node of the network, a first message comprising identity information for use in identifying one or more remote UEs to the first network node, wherein the relay UE is capable of relaying network traffic between the first network node and the one or more remote UEs when the first network node is serving the one or more remote UEs; and
   in response to signaling from a remote UE that identity information is needed, initiating (508) transmission of identity information towards the remote UE, wherein the identity information is for use in identifying the remote UE to the first network node when the first network node is serving the remote UE.
13. The method of embodiment 12, wherein:
   the transmission of the identity information is initiated over a sidelink interface between the remote UE and the relay UE or over a Packet Control Unit, PCU, in a predefined protocol layer.
14. The method of embodiment 12 or 13, wherein:
   for a remote UE of the one or more UEs:
      the method comprises allocating identity information to the remote UE; or
      the first message comprises the identity information allocated to the remote UE by the first network node.
15. The method of any of embodiments 12 to 14, the method comprising:
   signaling to the first network node, wherein the signaling is indicative that the relay UE is capable of relaying network traffic between the first network node and one or more remote UEs when the first network node is serving the one or more remote UEs.
16. The method of embodiment 15, wherein:
   the signaling is indicative that the relay UE is capable of relaying network traffic by the signaling comprising any one or more of:
      an indication of whether or not valid identity information is already allocated to a remote UE;
      a request for identity information to be allocated to a remote UE;
      an identifier that identifies a remote UE;
      an indication that the signaling is from the remote UE via the relay UE;
      an indication that identity information needs to be allocated to a remote UE;
      a request for a Radio Resource Control connection to be set up for the remote UE;
      a request for the remote UE to randomly access the first network node; and
      information indicative that the relay UE is to relay network traffic between the first network node and one or more remote UEs.
17. The method of embodiment 16, wherein:
   the identifier that identifies a remote UE signals that an RRC connection is to be set up for the remote UE; and/or
   the signaling further comprises information on a pairing between the remote UE and the relay UE, wherein the information on the pairing signals that an RRC connection is to be set up for the remote UE.
18. The method of embodiment 16 or 17, wherein:
   the signaling comprises any one or more of the indication of whether or not valid identity information is already allocated to a remote UE, the request for identity information to be allocated to a remote UE, and an identifier that identifies a remote UE; and
   the signaling is over a sidelink interface between the remote UE and the relay UE or over a Packet Control Unit, PCU, in a predefined protocol layer; and/or
   the signaling only occurs if the identity information already allocated to a remote UE is invalid and/or the first network node is a different network node to a second network node of the network that last served the remote UE.
19. The method of any of embodiments 16 to 18, wherein:
   the signaling comprises one or both of the indication that the signaling is from the remote UE via the relay UE and the indication that identity information needs to be allocated to a remote UE; and
   the signaling is RRC signaling.
20. The method of any of embodiments 16 to 19, wherein:
   the signaling comprises the request for an RRC connection to be setup for the remote UE if identity information already allocated to a remote UE is invalid and/or the relay UE is in an RRC connected state.
21. The method of any of embodiments 16 to 20, wherein:
   the signaling comprises the request for the remote UE to randomly access the first network node if one or both of the relay UE and the remote UE is in an RRC idle state.
22. The method of any of embodiments 16 to 21, wherein:
   the signaling further comprises a request for the relay UE to randomly access the first network node for the remote UE to set up an RRC connection; and
the method comprises receiving a second message from the first network node, wherein the second message comprises identity information for use in identifying the relay UE to the first network node.
23. The method of embodiment 22, wherein:
   the second message is the same message as the first message; or
   the second message is a different message from the first message.
24. The method of any of embodiments 16 to 23, wherein:
   the signaling is indicative that the relay UE is capable of relaying network traffic by the signaling indicating that a remote UE has connected to the first network node via the relay UE and/or the first network node has started to serve a remote UE via the relay UE.
25. The method of any of embodiments 16 to 24, wherein:
   the signaling comprises an indication that identity information needs to be allocated to a remote UE linked to the relay UE.
26. The method of embodiment 25, wherein:
   the relay UE is in an RRC connected state;
   the signaling is RRC signaling; and/or
   the signaling further comprises an identifier that identifies a remote UE.
27. The method of any of embodiments 16 to 26, wherein:
   the signaling further comprises an indication that the relay UE has transitioned to an RRC connected state.
28. The method of any of embodiments 16 to 27, wherein:
   the first message comprises identity information for use in identifying a plurality of remote UEs to the first network node.
29. The method of any of embodiments 16 to 28, the method comprising:
   initiating transmission of a third message towards the first network node, wherein the third message comprises an indication of the identity information, from the first message, allocated by the relay UE to one or more remote UEs.
30. A method for managing network traffic in a network, wherein the method is performed by an entity, the method comprising:
signaling (706) to a first network node, wherein the signaling is indicative that a relay user equipment, UE, is capable of relaying network traffic between the first network node and one or more remote UEs when the first network node is serving the one or more remote UEs.
31. The method of embodiment 30, wherein:
   the entity is a remote UE of the one or more remote UEs and the signaling is via the relay UE.
32. The method of embodiment 31, the method comprising:
   signaling to the relay UE that identity information is needed, wherein the identity information is for use in identifying a remote UE of the one or more remote UEs to the first network node when the first network node is serving the remote UE; and
   receiving the identity information from the relay UE.
33. The method of embodiment 32, wherein:
   the identity information is received from the relay UE over a sidelink interface between the remote UE and the relay UE or over a Packet Control Unit, PCU, in a predefined protocol layer; and/or
   the identity information is received in a Uu Radio Resource Control, RRC, message.
34. The method of embodiment 32 or 33, wherein:
   the identity information is allocated to the remote UE by the first network node or by the relay UE.
35. The method of any of embodiments 32 to 34, wherein:
   the signaling is indicative that the relay UE is capable of relaying network traffic by the signaling comprising any one or more of:
      an indication of whether or not valid identity information is already allocated to the remote UE;
      a request for identity information to be allocated to the remote UE;
      an identifier that identifies the remote UE;
      an indication that the signaling is from the remote UE via the relay UE;
      an indication that identity information needs to be allocated to the remote UE;
      a request for a Radio Resource Control connection to be set up for the remote UE;
      a request for the remote UE to randomly access the first network node; and
      information indicative that the relay UE is to relay network traffic between the first network node and the remote UE.
36. The method of embodiment 35, wherein:
   the identifier that identifies the remote UE signals that an RRC connection is to be set up for the remote UE; and/or
   the signaling further comprises information on a pairing between the remote UE and the relay UE, wherein the information on the pairing signals that an RRC connection is to be set up for the remote UE.
37. The method of embodiment 35 or 36, wherein:
   the signaling comprises any one or more of the indication of whether or not valid identity information is already allocated to the remote UE, the request for identity information to be allocated to the remote UE, and the identifier that identifies the remote UE; and
   the signaling is over a sidelink interface between the remote UE and the relay UE or over a Packet Control Unit, PCU, in a predefined protocol layer; and/or
   the signaling only occurs if the identity information already allocated to the remote UE is invalid and/or the first network node is a different network node to a second network node of the network that last served the remote UE.
38. The method of any of embodiments 32 to 37, wherein:
   the signaling comprises one or both of the indication that the signaling is from the remote UE via the relay UE and the indication that identity information needs to be allocated to the remote UE; and
   the signaling is RRC signaling.
39. The method of any of embodiments 32 to 38, wherein:
   the signaling comprises the request for the RRC connection to be set up for the remote UE if identity information already allocated to the remote UE is invalid and/or the relay UE is in an RRC connected state.
40. The method of any of embodiments 32 to 39, wherein:
   the signaling comprises the request for the remote UE to randomly access the first network node if one or both of the relay UE and the remote UE is in an RRC idle state.
41. The method of any of embodiments 32 to 40, wherein:
   the signaling is indicative that the relay UE is capable of relaying network traffic by the signaling indicating that the remote UE has connected to the first network node via the relay UE and/or the first network node has started to serve the remote UE via the relay UE.
42. The method of embodiment 30, wherein:
   the entity is the relay UE.
43. The method of embodiment 42, the method comprises:
   receiving, from the first network node of the network, a first message comprising identity information for use in identifying the one or more remote UEs to the first network node; and
   in response to signaling from a remote UE that identity information is needed, initiating transmission of identity information towards the remote UE, wherein the identity information is for use in identifying the remote UE to the first network node when the first network node is serving the remote UE.
44. The method of embodiment 43, wherein:
   the transmission of the identity information is initiated over a sidelink interface between the remote UE and the relay UE or over a Packet Control Unit, PCU, in a predefined protocol layer.
45. The method of embodiment 43 or 44, wherein:
   for a remote UE of the one or more UEs:
      the method comprises allocating identity information to the remote UE; or
      the first message comprises the identity information allocated to the remote UE by the first network node.
46. The method of embodiment 45, wherein:
   the signaling is indicative that the relay UE is capable of relaying network traffic by the signaling comprising any one or more of:
      an indication of whether or not valid identity information is already allocated to a remote UE;
      a request for identity information to be allocated to a remote UE;
      an identifier that identifies a remote UE;
      an indication that the signaling is from the remote UE via the relay UE;
      an indication that identity information needs to be allocated to a remote UE;
      a request for a Radio Resource Control connection to be set up for the remote UE;
      a request for the remote UE to randomly access the first network node; and
      information indicative that the relay UE is to relay network traffic between the first network node and one or more remote UEs.
47. The method of embodiment 46, wherein:
   the identifier that identifies a remote UE signals that an RRC connection is to be set up for the remote UE; and/or
   the signaling further comprises information on a pairing between the remote UE and the relay UE, wherein the information on the pairing signals that an RRC connection is to be set up for the remote UE.
48. The method of embodiment 46 or 47, wherein:
   the signaling comprises any one or more of the indication of whether or not valid identity information is already allocated to a remote UE, the request for identity information to be allocated to a remote UE, and an identifier that identifies a remote UE; and
   the signaling is over a sidelink interface between the remote UE and the relay UE or over a Packet Control Unit, PCU, in a predefined protocol layer; and/or
   the signaling only occurs if the identity information already allocated to a remote UE is invalid and/or the first network node is a different network node to a second network node of the network that last served the remote UE.
49. The method of any of embodiments 46 to 48, wherein:
   the signaling comprises one or both of the indication that the signaling is from the remote UE via the relay UE and the indication that identity information needs to be allocated to a remote UE; and
   the signaling is RRC signaling.
50. The method of any of embodiments 46 to 49, wherein:
   the signaling comprises the request for an RRC connection to be set up for the remote UE if identity information already allocated to a remote UE is invalid and/or the relay UE is in an RRC connected state.
51. The method of any of embodiments 46 to 50, wherein:
   the signaling comprises the request for the remote UE to randomly access the first network node if one or both of the relay UE and the remote UE is in an RRC idle state.
52. The method of any of embodiments 46 to 51, wherein:
   the signaling further comprises a request for the relay UE to randomly access the first network node for the remote UE to set up an RRC connection; and
   the method comprises receiving a second message from the first network node, wherein the second message comprises identity information for use in identifying the relay UE to the first network node.
53. The method of any of embodiments 46 to 52, wherein:
   the signaling is indicative that the relay UE is capable of relaying network traffic by the signaling indicating that a remote UE has connected to the first network node via the relay UE and/or the first network node has started to serve a remote UE via the relay UE.
54. The method of any of embodiments 46 to 53, wherein:
   the signaling comprises an indication that identity information needs to be allocated to a remote UE linked to the relay UE.
55. The method of embodiment 54, wherein:
   the relay UE is in an RRC connected state;
   the signaling is RRC signaling; and/or
   the signaling further comprises an identifier that identifies a remote UE.
56. The method of any of embodiments 46 to 55, wherein:
   the signaling further comprises an indication that the relay UE has transitioned to an RRC connected state.
57. The method of any of embodiments 43 to 56, wherein:
   the first message comprises identity information for use in identifying a plurality of remote UEs to the first network node.
58. The method of any of embodiments 43 to 57, the method comprising:
   initiating transmission of a third message towards the first network node, wherein the third message comprises an indication of the identity information, from the first message, allocated by the relay UE to one or more remote UEs.
59. The method of any of the previous embodiments, wherein:
   the identity information comprises:
      a Radio Network Temporary Identifier, RNTI; and/or
      a Layer 2 identifier, L2 ID, or a Layer 3 identifier, L3 ID, for the remote UE.
60. The of embodiment 59, wherein:
   the RNTI comprises a Cell RNTI, C-RNTI; and/or
   a Sidelink Relay RNTI, SR-RNTI.
61. The method of any of the previous embodiments, further comprising:
   providing user data; and
   forwarding the user data to a host via the transmission to the network node.

### Group B Embodiments

62. A method for managing network traffic in a network, wherein the method is performed by a first network node of the network, the method comprising:
   in response to signaling from an entity, wherein the signaling is indicative that a relay user equipment, UE, is capable of relaying network traffic between the first network node and one or more remote UEs when the first network node is serving the one or more remote UEs:
      initiating (606) transmission of a first message towards the relay UE, wherein the first message comprises identity information for use in identifying the one or more remote UEs to the first network node.
63. The method of embodiment 62, wherein:
   the entity is the relay UE;
   the entity is the remote UE and the signaling is via the relay UE; or
   the entity is a second network node of the network, wherein the second network node is a network node that last served the remote UE.
64. The method of embodiment 62 or 63, the method comprising:
   for a remote UE of the one or more UEs, allocating identity information to the remote UE.
65. The method of embodiment 64, wherein:
   the first message comprises the identity information allocated to the remote UE.
66. The method of any of embodiments 62 to 65, wherein:
   the entity is the relay UE or the entity is the remote UE and the signaling is via the relay UE; and
   the signaling is indicative that the relay UE is capable of relaying network traffic by the signaling comprising any one or more of:
      an indication of whether or not valid identity information is already allocated to a remote UE;
      a request for identity information to be allocated to a remote UE;
      an identifier that identifies a remote UE;
      an indication that the signaling is from the remote UE via the relay UE;
      an indication that identity information needs to be allocated to a remote UE;
      a request for a Radio Resource Control connection to be set up for the remote UE;
      a request for the remote UE to randomly access the first network node; and
      information indicative that the relay UE is to relay network traffic between the first network node and one or more remote UEs.
67. The method of embodiment 66, wherein:
   the identifier that identifies a remote UE signals that an RRC connection is to be set up for the remote UE; and/or
   the signaling further comprises information on a pairing between the remote UE and the relay UE, wherein the information on the pairing signals that an RRC connection is to be set up for the remote UE.
68. The method of embodiment 66 or 67, wherein:
   the signaling comprises any one or more of the indication of whether or not valid identity information is already allocated to a remote UE, the request for identity information to be allocated to a remote UE, and an identifier that identifies a remote UE; and
   the signaling is over a sidelink interface between the remote UE and the relay UE or over a Packet Control Unit, PCU, in a predefined protocol layer; and/or
   the signaling only occurs if the identity information already allocated to a remote UE is invalid and/or the first network node is a different network node to a second network node of the network that last served the remote UE.
69. The method of any of embodiments 66 to 68, wherein:
   the signaling comprises one or both of the indication that the signaling is from the remote UE via the relay UE and the indication that identity information needs to be allocated to a remote UE; and
   the signaling is RRC signaling.
70. The method of any of embodiments 66 to 69, wherein:
   the signaling comprises the request for an RRC connection to be set up for the remote UE if identity information already allocated to a remote UE is invalid and/or the relay UE is in an RRC connected state.
71. The method of any of embodiments 66 to 70, wherein:
   the signaling comprises the request for the remote UE to randomly access the first network node if one or both of the relay UE and the remote UE is in an RRC idle state.
72. The method of any of embodiments 66 to 71, wherein:
   the signaling further comprises a request for the relay UE to randomly access the first network node for the remote UE to set up an RRC connection; and
   the method comprises initiating transmission of a second message towards the relay UE, wherein the second message comprises identity information for use in identifying the relay UE to the first network node.
73. The method of embodiment 72, wherein:
   the second message is the same message as the first message; or
   the second message is a different message from the first message.
74. The method of any of embodiments 66 to 73, wherein:
   the signaling is indicative that the relay UE is capable of relaying network traffic by the signaling indicating that a remote UE has connected to the first network node via the relay UE and/or the first network node has started to serve a remote UE via the relay UE.
75. The method of any of embodiments 62 to 74, wherein:
   the entity is the relay UE; and
   the signaling comprises an indication that identity information needs to be allocated to a remote UE linked to the relay UE.
76. The method of embodiment 75, wherein:
   the relay UE is in an RRC connected state;
   the signaling is RRC signaling; and/or
   the signaling further comprises an identifier that identifies a remote UE.
77. The method of any of embodiments 62 to 76, wherein:
   the signaling further comprises an indication that the relay UE has transitioned to an RRC connected state.
78. The method of any of embodiments 62 to 77, wherein:
   the first message comprises identity information for use in identifying a plurality of remote UEs to the first network node.
79. The method of any of embodiments 62 to 78, the method comprising:
   receiving a third message comprising an indication of the identity information, from the first message, allocated by the relay UE to one or more remote UEs.
80. The method of any of embodiments 62 to 79, wherein:
   the identity information comprises:
      a Radio Network Temporary Identifier, RNTI; and/or
      a Layer 2 identifier, L2 ID, or a Layer 3 identifier, L3 ID, for the remote UE.
81. The of embodiment 80, wherein:
   the RNTI comprises a Cell RNTI, C-RNTI; and/or
   a Sidelink Relay RNTI, SR-RNTI.
82. The method of any of embodiments 62 to 81, further comprising:
   obtaining user data; and
   forwarding the user data to a host or a user equipment.
83. A method for managing network traffic in a network, wherein the method is performed by an entity, the method comprising:
   signaling (706) to a first network node, wherein the signaling is indicative that a relay user equipment, UE, is capable of relaying network traffic between the first network node and one or more remote UEs when the first network node is serving the one or more remote UEs.
84. The method of embodiment 83, wherein:
   the entity is a second network node of the network, wherein the second network node is a network node that last served the one or more UEs.

### Group C Embodiments

85. A user equipment for managing network traffic in a network, comprising:
   processing circuitry configured to cause the user equipment to perform any of the steps of any of the Group A embodiments; and
   power supply circuitry configured to supply power to the processing circuitry.
86. A network node for managing network traffic in a network, the network node comprising:
   processing circuitry configured to cause the network node to perform any of the steps of any of the Group B embodiments;
   power supply circuitry configured to supply power to the processing circuitry.
87. A user equipment (UE) for managing network traffic in a network, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
a battery connected to the processing circuitry and configured to supply power to the UE.
88. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
89. The host of the previous embodiment, wherein the cellular network further includes
   a network node configured to communicate with the UE to transmit the user data to the UE from the host.
90. The host of the previous 2 embodiments, wherein:
   the processing circuitry of the host is configured to execute a host application, thereby providing the user data; and
   the host application is configured to interact with a client application executing on the UE, the client application being associated with the host application.
91. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
92. The method of the previous embodiment, further comprising:
   at the host, executing a host application associated with a client application executing on the UE to receive the user data from the UE.
93. The method of the previous embodiment, further comprising:
   at the host, transmitting input data to the client application executing on the UE, the input data being provided by executing the host application,
   wherein the user data is provided by the client application in response to the input data from the host application.
94. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.
95. The host of the previous embodiment, wherein the cellular network further includes a network node configured to communicate with the UE to transmit the user data from the UE to the host.
96. The host of the previous 2 embodiments, wherein:
   the processing circuitry of the host is configured to execute a host application, thereby providing the user data; and
   the host application is configured to interact with a client application executing on the UE, the client application being associated with the host application.
97. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.
98. The method of the previous embodiment, further comprising:
   at the host, executing a host application associated with a client application executing on the UE to receive the user data from the UE.
99. The method of the previous embodiment, further comprising:
   at the host, transmitting input data to the client application executing on the UE, the input data being provided by executing the host application,
   wherein the user data is provided by the client application in response to the input data from the host application.
100. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
101. The host of the previous embodiment, wherein:
   the processing circuitry of the host is configured to execute a host application that provides the user data; and
   the UE comprises processing circuitry configured to execute a client application associated with the host application to receive the transmission of user data from the host.
102. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
103. The method of the previous embodiment, further comprising, at the network node, transmitting the user data provided by the host for the UE.
104. The method of any of the previous 2 embodiments, wherein the user data is provided at the host by executing a host application that interacts with a client application executing on the UE, the client application being associated with the host application.
105. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
106. The communication system of the previous embodiment, further comprising:
   the network node; and/or
   the user equipment.
107. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
108. The host of the previous 2 embodiments, wherein:
   the processing circuitry of the host is configured to execute a host application, thereby providing the user data; and
   the host application is configured to interact with a client application executing on the UE, the client application being associated with the host application.
109. The host of the any of the previous 2 embodiments, wherein the initiating receipt of the user data comprises requesting the user data.
110. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
111. The method of the previous embodiment, further comprising at the network node, transmitting the received user data to the host.

### REFERENCES

1. RP-210823, New WID on NR Sidelink Relay
2. TR 38.836, V17.0.0, “Study on NR sidelink relay; (Release 17)”
3. TS 38.331 V16.2.0, “Radio Resource Control (RRC) protocol specification (Release 16)”
4. TS 38.321 V16.2.1, “Medium Access Control (MAC) protocol specification (Release 16)”

### Abbreviations

At least some of the following abbreviations may be used in this disclosure. If there is an inconsistency between abbreviations, preference should be given to how it is used above. If listed multiple times below, the first listing should be preferred over any subsequent listing(s).
CA Carrier Aggregation
CBR Channel Busy Ratio
CQI Channel Quality Indicator
CSI Channel State Information
DFN Direct Frame Number
DL Downlink
DRX Discontinuous Reception
FDD Frequency Division Duplex
GNSS Global Navigation Satellite System
HARQ Hybrid automatic repeat request
IE Information Element
MAC Medium Access Control
MIB Master Information Block
NSPS National Security and Public Safety
OoC Out-of-Coverage
PDCCH Physical Downlink Control Channel
PDCP Packet Data Convergence Protocol
PDU Protocol Data Unit
PHY Physical (layer)
PL Path Loss
PMI Precoding Matrix Indicator
ProSe Proximity Services
PSCCH Physical Sidelink Control Channel
PSSCH Physical Sidelink Shared Channel
RL Relay
RLC Radio link control
RM Remote
RI Rank Indicator
RRC Radio Resource Control
RSRP Reference Signal Received Power
RSSI Received Signal Strength Indicator
RX Receive, receiver
SFN System Frame Number
SIB System Information Block
SINR Signal to interference noise ration
SL Sidelink
SLRB Sidelink Radio Bearer
SLSS Sidelink Synchronization Signals
SMF Session Management Function
SynchUE Synchronization UE
SR-RNTI Sidelink Relay Radio Network Temporary Identifier
TDD Time Division Duplex
TETRA Terrestrial Trunked Radio
TX Transmit, transmitter
UE User Equipment
UL Uplink
UPF User Plane Function
V2V Vehicle-to-vehicle
V2X Vehicle-to-anything
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1.-47. (canceled)

48. A method for managing network traffic in a network, wherein the method is performed by a remote user equipment, UE, the method comprising:
receiving a first message from a first network node via a relay UE in response to signaling from the remote UE to the first network node via the relay UE,
wherein one or both of the relay UE and the remote UE is in a radio resource control, RRC, idle state and the signaling to the first network node comprises a first request for the remote UE to randomly access the first network node,
wherein the signaling to the first network node is indicative that the remote UE is to be served by the first network node via the relay UE by the signaling to the first network node comprising the first request for the remote UE to randomly access the first network node,
wherein the first message comprises identity information for use in identifying the remote UE to the first network node when the first network node is serving the remote UE and wherein the relay UE is capable of relaying network traffic between the first network node and the remote UE when the first network node is serving the remote UE.

49. The method of claim 48, wherein:
the first message is received over a sidelink interface between the remote UE and the relay UE and a Uu interface between the relay UE and the first network node or over a Packet Control Unit, PCU, in a predefined protocol layer; and/or
the first message is received in a Uu RRC message.

50. The method of claim 48, wherein:
the identity information is allocated to the remote UE by the first network node or by the relay UE.

51. The method of claim 48, wherein:
the signaling to the first network node comprises a second request and the first message is a response to the second request, wherein:
the second request is a request for a connection to be established for the remote UE to be served by the first network node via the relay UE and the response comprises an instruction for the remote UE to use the established connection;
the second request is a request for a connection to be resumed for the remote UE to be served by the first network node via the relay UE and the response comprises an instruction for the remote UE to use the resumed connection;
the second request is a request for a connection to be re-established for the remote UE to be served by the first network node via the relay UE and the response comprises an instruction for the remote UE to use the re-established connection; or
the second request is a request for a connection to be re-configured for the remote UE to be served by the first network node via the relay UE and the response comprises an instruction for the remote UE to use the re-configured connection.

52. The method of claim 48, wherein:
the signaling to the first network node is indicative that the remote UE is to be served by the first network node via the relay UE by the signaling to the first network node comprising any one or more of:
an indication of whether or not valid identity information is already allocated to the remote UE;
a third request for identity information to be allocated to the remote UE;
an identifier that identifies the remote UE;
an indication that the signaling to the first network node is from the remote UE via the relay UE;
an indication that identity information needs to be allocated to the remote UE;
a fourth request for an RRC connection to be set up for the remote UE; and
information indicative that the relay UE is to relay network traffic between the first network node and the remote UE.

53. The method of claim 52, wherein:
the identifier that identifies the remote UE signals that an RRC connection is to be set up for the remote UE; and/or
the signaling to the first network node further comprises information on a pairing between the remote UE and the relay UE, wherein the information on the pairing signals that an RRC connection is to be set up for the remote UE.

54. The method of claim 52, wherein:
the signaling to the first network node comprises any one or more of the indication of whether or not valid identity information is already allocated to the remote UE, the third request for identity information to be allocated to the remote UE, and the identifier that identifies the remote UE; and
the signaling to the first network node is over a sidelink interface between the remote UE and the relay UE and a Uu interface between the relay UE and the first network node or over a Packet Control Unit, PCU, in a predefined protocol layer; and/or
the signaling to the first network node only occurs if the identity information already allocated to the remote UE is invalid and/or the first network node is a different network node to a second network node of the network that last served the remote UE.

55. The method of claim 52, wherein:
the signaling to the first network node comprises:
one or both of the indication that the signaling to the first network node is from the remote UE via the relay UE and the indication that identity information needs to be allocated to the remote UE, wherein the signaling to the first network node is RRC signaling; and/or
the fourth request for the RRC connection to be set up for the remote UE if identity information already allocated to the remote UE is invalid and/or the relay UE is in an RRC connected state.

56. The method of claim 48, wherein:
the signaling to the first network node is indicative that the remote UE is to be served by the first network node via the relay UE by the signaling to the first network node indicating that the remote UE has connected to the first network node via the relay UE and/or the first network node has started to serve the remote UE via the relay UE.

57. A method for managing network traffic in a network, wherein the method is performed by a relay user equipment, UE, the method comprising:
receiving, from a first network node of the network, a first message destined for a remote UE and comprising identity information for use in identifying the remote UE to the first network node when the first network node is serving the remote UE, wherein the relay UE is capable of relaying network traffic between the first network node and the remote UE when the first network node is serving the remote UE; and
initiating transmission of the first message comprising the identity information towards the remote UE in response to signaling from the remote UE to the first network node via the relay UE,
wherein one or both of the relay UE and the remote UE is in a radio resource control, RRC, idle state and the signaling from the remote UE comprises a first request for the remote UE to randomly access the first network node, and
wherein the signaling from the remote UE is indicative that the remote UE is to be served by the first network node via the relay UE by the signaling from the remote UE comprising the first request for the remote UE to randomly access the first network node.

58. The method of claim 57, wherein:
the transmission of the first message is initiated over a sidelink interface between the remote UE and the relay UE or over a Packet Control Unit, PCU, in a predefined protocol layer.

59. The method of claim 57, wherein:
the signaling from the remote UE comprises a second request and the first message is a response to the second request, wherein:
the second request is a request for a connection to be established for the remote UE to be served by the first network node via the relay UE and the response comprises an instruction for the remote UE to use the established connection;
the second request is a request for a connection to be resumed for the remote UE to be served by the first network node via the relay UE and the response comprises an instruction for the remote UE to use the resumed connection;
the second request is a request for a connection to be re-established for the remote UE to be served by the first network node via the relay UE and the response comprises an instruction for the remote UE to use the re-established connection; or
the second request is a request for a connection to be re-configured for the remote UE to be served by the first network node via the relay UE and the response comprises an instruction for the remote UE to use the re-configured connection.

60. The method of claim 57, wherein:
the signaling from the remote UE is indicative that the remote UE is to be served by the first network node via the relay UE by the signaling from the remote UE comprising any one or more of:
an indication of whether or not valid identity information is already allocated to the remote UE;
a third request for identity information to be allocated to the remote UE;
an identifier that identifies the remote UE;
an indication that identity information needs to be allocated to the remote UE;
a fourth request for an RRC connection to be set up for the remote UE; and
information indicative that the relay UE is to relay network traffic between the first network node and the remote UE.

61. The method of claim 60, wherein:
the identifier that identifies the remote UE signals that an RRC connection is to be set up for the remote UE; and/or
the signaling from the remote UE further comprises information on a pairing between the remote UE and the relay UE, wherein the information on the pairing signals that an RRC connection is to be set up for the remote UE.

62. The method of claim 60, wherein:
the signaling from the remote UE comprises any one or more of the indication of whether or not valid identity information is already allocated to the remote UE, the third request for identity information to be allocated to the remote UE, and an identifier that identifies the remote UE; and
the signaling from the remote UE is over a sidelink interface between the remote UE and the relay UE and a Uu interface between the relay UE and the first network node or over a Packet Control Unit, PCU, in a predefined protocol layer; and/or
the signaling from the remote UE only occurs if the identity information already allocated to the remote UE is invalid and/or the first network node is a different network node to a second network node of the network that last served the remote UE.

63. The method of claim 60, wherein:
the signaling from the remote UE comprises:
the indication that identity information needs to be allocated to the remote UE, wherein the signaling from the remote UE is RRC signaling; and/or
the fourth request for an RRC connection to be set up for the remote UE if identity information already allocated to the remote UE is invalid and/or the relay UE is in an RRC connected state.

64. The method of claim 60, wherein:
the signaling from the remote UE is indicative that the remote UE is to be served by the first network node via the relay UE by the signaling from the remote UE indicating that the remote UE has connected to the first network node via the relay UE and/or the first network node has started to serve the remote UE via the relay UE.

65. The method of claim 60, the method comprising:
signaling to the first network node, wherein the signaling to the first network node is indicative that the remote UE is to be served by the first network node via the relay UE, wherein the first message is received in response to the signaling to the first network node.

66. The method of claim 65, wherein:
the signaling to the first network node is indicative that the remote UE is to be served by the first network node via the relay UE by the signaling to the first network node comprising any one or more of:
an indication of whether or not valid identity information is already allocated to the remote UE;
a third request for identity information to be allocated to the remote UE;
an identifier that identifies the remote UE;
an indication that the signaling to the first network node is from the remote UE via the relay UE;
an indication that identity information needs to be allocated to the remote UE;
a fourth request for an RRC connection to be set up for the remote UE; and
information indicative that the relay UE is to relay network traffic between the first network node and the remote UE.

67. The method of claim 66, wherein:
the identifier that identifies the remote UE signals that an RRC connection is to be set up for the remote UE; and/or
the signaling to the first network node further comprises information on a pairing between the remote UE and the relay UE, wherein the information on the pairing signals that an RRC connection is to be set up for the remote UE.

68. The method of claim 66, wherein:
the signaling to the first network node comprises any one or more of the indication of whether or not valid identity information is already allocated to the remote UE, the third request for identity information to be allocated to the remote UE, and an identifier that identifies the remote UE; and
the signaling to the first network node is over a sidelink interface between the remote UE and the relay UE and a Uu interface between the relay UE and the first network node or over a Packet Control Unit, PCU, in a predefined protocol layer; and/or
the signaling to the first network node only occurs if the identity information already allocated to the remote UE is invalid and/or the first network node is a different network node to a second network node of the network that last served the remote UE.

69. The method of claim 66, wherein:
the signaling to the first network node comprises:
one or both of the indication that the signaling to the first network node is from the remote UE via the relay UE and the indication that identity information needs to be allocated to the remote UE, wherein the signaling to the first network node is RRC signaling; and/or
the fourth request for an RRC connection to be set up for the remote UE if identity information already allocated to the remote UE is invalid and/or the relay UE is in an RRC connected state.

70. The method of claim 65, wherein:
the signaling to the first network node is indicative that the remote UE is to be served by the first network node via the relay UE by the signaling to the first network node indicating that the remote UE has connected to the first network node via the relay UE and/or the first network node has started to serve the remote UE via the relay UE.

71. A method for managing network traffic in a network, wherein the method is performed by a first network node of the network, the method comprising:
initiating transmission of a first message towards a remote user equipment, UE, via a relay UE in response to signaling from an entity, wherein the entity is the remote UE and the signaling is via the relay UE or the entity is the relay UE,
wherein one or both of the relay UE and the remote UE is in a radio resource control, RRC, idle state and the signaling from the entity comprises a first request for the remote UE to randomly access the first network node,
wherein the signaling from the entity is indicative that the remote UE is to be served by the first network node via the relay UE by the signaling from the entity comprising the first request for the remote UE to randomly access the first network node,
wherein the relay UE is capable of relaying network traffic between the first network node and the remote UE when the first network node is serving the remote UE, and wherein the first message comprises identity information for use in identifying the remote UE to the first network node when the first network node is serving the remote UE.

72. The method of claim 71, wherein:
the signaling comprises a second request and the first message is a response to the second request, wherein:
the second request is a request for a connection to be established for the remote UE to be served by the first network node via the relay UE and the response comprises an instruction for the remote UE to use the established connection;
the second request is a request for a connection to be resumed for the remote UE to be served by the first network node via the relay UE and the response comprises an instruction for the remote UE to use the resumed connection;
the second request is a request for a connection to be re-established for the remote UE to be served by the first network node via the relay UE and the response comprises an instruction for the remote UE to use the re-established connection; or
the second request is a request for a connection to be re-configured for the remote UE to be served by the first network node via the relay UE and the response comprises an instruction for the remote UE to use the re-configured connection.

73. The method of claim 71, wherein:
the signaling is indicative that the remote UE is to be served by the first network node via the relay UE by the signaling comprising any one or more of:
an indication of whether or not valid identity information is already allocated to the remote UE;
a third request for identity information to be allocated to the remote UE;
an identifier that identifies the remote UE;
an indication that the signaling is from the remote UE via the relay UE;
an indication that identity information needs to be allocated to the remote UE;
a fourth request for an RRC connection to be set up for the remote UE; and
information indicative that the relay UE is to relay network traffic between the first network node and the remote UE.

74. The method of claim 73, wherein:
the identifier that identifies the remote UE signals that an RRC connection is to be set up for the remote UE; and/or
the signaling further comprises information on a pairing between the remote UE and the relay UE, wherein the information on the pairing signals that an RRC connection is to be set up for the remote UE.

75. The method of claim 73, wherein:
the signaling comprises any one or more of the indication of whether or not valid identity information is already allocated to the remote UE, the third request for identity information to be allocated to the remote UE, and an identifier that identifies the remote UE; and
the signaling is over a sidelink interface between the remote UE and the relay UE and a Uu interface between the relay UE and the first network node or over a Packet Control Unit, PCU, in a predefined protocol layer; and/or
the signaling only occurs if the identity information already allocated to the remote UE is invalid and/or the first network node is a different network node to a second network node of the network that last served the remote UE.

76. The method of claim 73, wherein:
the signaling comprises:
one or both of the indication that the signaling is from the remote UE via the relay UE and the indication that identity information needs to be allocated to the remote UE, wherein the signaling is RRC signaling; and/or
the fourth request for an RRC connection to be set up for the remote UE if identity information already allocated to the remote UE is invalid and/or the relay UE is in an RRC connected state.

77. The method of claim 71, wherein:
the signaling is indicative that the remote UE is to be served by the first network node via the relay UE by the signaling indicating that the remote UE has connected to the first network node via the relay UE and/or the first network node has started to serve the remote UE via the relay UE.
